(19) United States
(12) Patent Application Publication
(10) Pub. No.: US 2024/0306044 A1
(43) Pub. Date: Sep. 12, 2024

(54) NETWORK HANDOVER METHOD AND COMMUNICATION APPARATUS

(71) Applicant: HUAWEI TECHNOLOGIES CO., LTD., Shenzhen (CN)

(72) Inventors: Dongdong WEI, Shanghai (CN); Yongxia LYU, Shenzhen (CN); Jianglei MA, Ottawa (CA); Ting WANG, Shanghai (CN)

(21) Appl. No.: 18/660,982

(22) Filed: May 10, 2024

Related U.S. Application Data
(63) Continuation of application No. PCT/CN2022/135076, filed on Nov. 29, 2022.

(30) Foreign Application Priority Data
Nov. 30, 2021 (CN) 202111448983.1

(51) Int. Cl. H04W 36/00; H04W 52/02

(52) U.S. Cl. CPC H04W 36/0009; H04W 36/0007; H04W 36/0061; H04W 52/0206

(57) ABSTRACT

A first access network device (AND) sends a first message to a second AND. The first message is usable to request to hand over a group of terminal devices under the first AND to the second AND. The group of terminal devices includes one or more terminal devices. In response to the first AND receiving a first response message from the second AND for the first message, the first AND sends a second message to the terminal devices. The first response message is usable to indicate that the terminal devices are allowed to be handed over to the second AND, and the second message is usable to indicate the terminal devices to be handed over to the second AND. After the terminal devices are handed over to the second AND, the first AND switches off one or more cells.

### CROSS-REFERENCE TO RELATED APPLICATIONS

This is a continuation of International Application No. PCT/CN2022/135076, filed on Nov. 29, 2022, which claims priority to Chinese Patent Application No. 202111448983.1, filed on Nov. 30, 2021. The disclosures of the aforementioned applications are hereby incorporated by reference in their entireties.

### BACKGROUND

To meet people's increasing traffic usage, wireless networks are constantly under rapid construction. As a network scale increases, network energy consumption increases continuously, and expenditure of electricity fees greatly increases costs of an operator. For an access network device, the access network device notifies a neighboring base station and switches off a current cell only in response to there being no connected UE in the cell. However, in a scenario in which a quantity of UEs in the cell is small, energy is easily wasted.

### SUMMARY

Embodiments described herein provide a network handover method and a communication apparatus, to help reduce energy consumption of an access network device.

According to a first aspect, at least one embodiment provides a network handover method. The method includes: A first access network device sends a first message to a second access network device. The first message is usable to request to hand over a group of terminal devices under the first access network device to the second access network device, and the group of terminal devices includes one or more terminal devices. In response to the first access network device receiving a first response message from the second access network device for the first message, the first access network device sends a second message to the one or more terminal devices. The first response message is usable to indicate that the one or more terminal devices are allowed to be handed over to the second access network device, and the second message is usable to indicate the terminal devices to be handed over to the second access network device. After the one or more terminal devices are handed over to the second access network device, the first access network device switches off one or more cells.

Based on the method described in the first aspect, the first access network device interacts with the second access network device and the terminal, so that the first access network device uniformly hands over the group of terminal devices to the second access network device and then switch off the cells, so as to enable the first access network device to switch off the cells. Energy is effectively saved without affecting user experience, and the cells are switched off without waiting for a case that there is no terminal device that is performing data transmission in the cells. This helps reduce energy consumption of the first access network device.

In at least one embodiment, a specific implementation in which the first access network device sends the second message to the one or more terminal devices is: The first access network device multicasts the second message to the one or more terminal devices. The second message includes dedicated configuration information and common configuration information, the dedicated configuration information includes one or more of the following: random access channel (RACH) configuration information of the one or more terminal devices, or channel state information (CSI) or measurement configuration information of the one or more terminal devices, and the common configuration information includes one or more of the following: physical downlink control channel (PDCCH) configuration information, physical downlink shared channel (PDSCH) configuration information, physical uplink control channel (PUCCH) configuration information, or physical uplink shared channel (PUSCH) configuration information. Based on this implementation, one message carries information about a plurality of terminal devices. This avoids repeated sending of a common configuration, and helps reduce signaling overheads.

In at least one embodiment, a specific implementation in which the first access network device sends the second message to the one or more terminal devices is: The first access network device multicasts the second message to the one or more terminal devices. The second message carries common configuration information, and the common configuration information includes one or more of the following: physical downlink control channel (PDCCH) configuration information, physical downlink shared channel (PDSCH) configuration information, physical uplink control channel (PUCCH) configuration information, or physical uplink shared channel (PUSCH) configuration information. The method further includes: The first access network device unicasts corresponding dedicated configuration information to the one or more terminal devices. The dedicated configuration information includes one or more of the following: random access channel (RACH) configuration information of the one or more terminal devices, or channel state information (CSI) or measurement configuration information of the one or more terminal devices. Based on this implementation, the dedicated configuration information received by the terminal device includes only configuration information usable by the terminal device, and has high security.

In at least one embodiment, before that a first access network device sends a first message to a second access network device, the method further includes: The first access network device sends a third message to the second access network device. The third message is used to request to switch off the one or more cells. The first access network device receives a third response message from the second access network device for the third message. The third response message is usable to indicate that the one or more cells are allowed to be switched off. This implementation helps the second access network device better manage the first access network device.

In at least one embodiment, the first message further is usable to indicate to request to switch off the one or more cells, and the first response message is usable to indicate that the one or more cells are allowed to be switched off. Based on this implementation, the first message is not only used to request to switch off the cells, but also used to request to hand over the group of terminals under the first access network device. This reduces signaling overheads.

In at least one embodiment, before the first access network device switches off the cells, the method further includes: The first access network device sends a fourth message to the second access network device. The fourth message is used to notify the second access network device that the first access network device is to switch off the one or more cells. Optionally, the first access network device receives a fourth response message from the second access network device for the fourth message. The fourth response message is usable to indicate that the one or more cells are allowed to be switched off. This implementation helps the second access network device better manage the first access network device.

In at least one embodiment, before the first access network device switches off the cells, the method further includes: The first access network device sends a fourth message to the second access network device. The fourth message is usable to indicate that the first access network device is to switch off the one or more cells.

In at least one embodiment, before the first access network device switches off the cells, the method further includes: The first access network device receives a twelfth message from the second access network device. The twelfth message is usable to indicate the first access network device to switch off the one or more cells.

In at least one embodiment, the method further includes: The first access network device receives a first configuration message from the second access network device. The first configuration message includes configuration information of a data radio bearer (DRB). The first access network device forwards data of a first terminal device to the second access network device through one or N DRBs corresponding to the first terminal device. The first terminal device is any one of the one or more terminal devices, and N is a positive integer and is greater than 1. This implementation helps provide different services for different terminal devices.

In at least one embodiment, the method further includes: The first access network device receives a second configuration message from the second access network device. The second configuration message includes configuration information of one or more data radio bearers (DRBs). The first access network device forwards data of a first terminal device to the second access network device through the one or more DRBs. A packet header of the data includes an identifier of the first terminal device and a length of the data, and the first terminal device is any one of the one or more terminal devices. Based on this implementation, establishing a DRB is more convenient.

In at least one embodiment, after that a first access network device sends a first message to a second access network device, the method further includes: The first access network device starts a timer. Timing duration of the timer is determined based on a type of the second access network device. In response to the timer expiring and the first access network device not receiving the first response message, the first access network device sends a sixth message to the second access network device. The sixth message is usable to indicate to cancel the handover of the one or more terminal devices. This implementation helps avoid waiting for the first response message of the second access network device for long time.

In at least one embodiment, after that the first access network device sends a second message to the one or more terminal devices, the method further includes: The first access network device sends a seventh message to the second access network device. The seventh message includes one or more of the following: a cell-radio network temporary identifier C-RNTI that corresponds to the terminal devices and that is of the first access network device, a C-RNTI that corresponds to the terminal devices and that is of the second access network device, a packet data convergence protocol (PDCP) sequence number of the DRB, and a hyper frame number (HFN).

In at least one embodiment, before the first access network device switches off the one or more cells, the method further includes: The first access network device receives a ninth message from the second access network device. The first access network device releases context information of the one or more terminal devices based on the ninth message. This implementation helps the first access network device reduce network load and save storage space.

According to a second aspect, at least one embodiment provides a network handover method. The method includes: A second access network device receives a first message sent by a first access network device. The first message is usable to request to hand over a group of terminal devices under the first access network device to the second access network device, and the group of terminal devices includes one or more terminal devices. The second access network device sends a first response message to the first access network device for the first message. The first response message is usable to indicate that the one or more terminal devices are allowed to be handed over to the second access network device. The second access network device receives a fifth message sent by the one or more terminal devices. The fifth message is usable to indicate that the terminal devices request to be handed over to the second access network device. For beneficial effects of the second aspect, refer to the content described in the first aspect.

In at least one embodiment, before that a second access network device receives a first message sent by a first access network device, the method further includes: The second access network device receives a third message from the first access network device. The third message is usable to request to switch off one or more cells. The second access network device sends a third response message to the first access network device for the third message. The third response message is usable to indicate that the one or more cells are allowed to be switched off.

In at least one embodiment, the first message further is usable to indicate to request to switch off one or more cells, and the first response message is usable to indicate that the one or more cells are allowed to be switched off.

In at least one embodiment, the method further includes: After the second access network device receives a fourth message from the first access network device, the second access network device sends a fourth response message to the first access network device for the fourth message. The fourth message is usable to indicate that the first access network device is to switch off the one or more cells, and the fourth response message is usable to indicate that the second access network device allows to switch off the one or more cells.

In at least one embodiment, the method further includes: The second access network device sends a twelfth message to the first access network device. The twelfth message is usable to indicate the first access network device to switch off the one or more cells.

In at least one embodiment, the method further includes: The second access network device sends a first configuration message to the first access network device. The first configuration message includes configuration information of a data radio bearer (DRB). The second access network device receives, through the DRB, data that is of a first terminal device corresponding to the DRB and that is sent by the first access network device. The first terminal device is any one of the one or more terminal devices.

In at least one embodiment, the method further includes: The second access network device sends a second configuration message to the first access network device. The second configuration message includes configuration information of one or more data radio bearers (DRBs). The second access network device receives, through the one or more DRBs, data forwarded by the first access network device. A packet header of the data includes an identifier of a first terminal device and a length of the data, the identifier is usable to indicate that the data is from the first terminal device, and the first terminal device is any one of the one or more terminal devices.

In at least one embodiment, the method further includes: In response to the second access network device not sending the first response message to the first access network device for the first message, the second access network device receives a sixth message sent by the first access network device. The sixth message is usable to indicate to cancel the handover of the one or more terminal devices.

In at least one embodiment, after that the second access network device sends a first response message to the first access network device for the first message, the method further includes: The second access network device receives a seventh message from the first access network device. The seventh message includes a C-RNTI that corresponds to the terminal devices and that is of the first access network device, a C-RNTI that corresponds to the terminal devices and that is of the second access network device, a packet data convergence protocol (PDCP) sequence number of the DRB, and a hyper frame number (HFN).

In at least one embodiment, after that the second access network device receives a fifth message sent by the one or more terminal devices, the method further includes: The second access network device sends an eighth message to a core network device. The eighth message is usable to indicate that the one or more terminal devices are handed over to the second access network device. The second access network device receives an eighth response message sent by the core network device for the eighth message.

In at least one embodiment, after that the second access network device receives a fifth message sent by the one or more terminal devices, the method further includes: The second access network device sends a ninth message to the first access network device. The ninth message is usable to indicate the first access network device to release context information of the one or more terminal devices.

According to a third aspect, at least one embodiment provides a network handover method. The method includes: A terminal device receives a second message sent by a first access network device. The second message is usable to indicate the terminal device to be handed over to a second access network device. The terminal device sends a fifth message to the second access network device. The fifth message is usable to request to be handed over to the second access network device.

Based on the method described in the third aspect, a group of terminal devices is simultaneously handed over to the second access network device, to reduce repeated transmission of a large amount of common information by the first access network device, and reduce network load.

In at least one embodiment, the second message includes dedicated configuration information and common configuration information, the dedicated configuration information includes one or more of the following: random access channel (RACH) configuration information of one or more terminal devices, or channel state information (CSI) or measurement configuration information of the one or more terminal devices, and the common configuration information includes one or more of the following: physical downlink control channel (PDCCH) configuration information, physical downlink shared channel (PDSCH) configuration information, physical uplink control channel (PUCCH) configuration information, or physical uplink shared channel (PUSCH) configuration information.

In at least one embodiment, the second message carries common configuration information, and the common configuration information includes one or more of the following: physical downlink control channel (PDCCH) configuration information, physical downlink shared channel (PDSCH) configuration information, physical uplink control channel (PUCCH) configuration information, or physical uplink shared channel (PUSCH) configuration information. The method further includes: The terminal device receives dedicated configuration information sent by the first access network device. The dedicated configuration information includes one or more of the following: random access channel (RACH) configuration information corresponding to the terminal device, or channel state information (CSI) or measurement configuration information of the terminal device.

According to a fourth aspect, at least one embodiment provides a network handover method. The method includes: A first access network device receives a first message sent by a second access network device. The first message is usable to request to hand over a group of terminal devices under the second access network device to the first access network device, and the group of terminal devices includes one or more terminal devices. The first access network device sends a first response message to the second access network device for the first message. The first response message is usable to indicate that the one or more terminal devices are allowed to be handed over to the first access network device. The first access network device receives a fifth message sent by the one or more terminal devices. The fifth message is usable to indicate that the terminal devices request to be handed over to the first access network device.

Based on the method described in the fourth aspect, in response to being overloaded, the second access network device hands over the one or more terminal devices to the first access network device. This helps reduce load of the second access network device.

In at least one embodiment, before the first access network device receives the first message sent by the second access network device, the first access network device receives a tenth message from the second access network device. The tenth message is usable to indicate the first access network device to switch on one or more cells.

In at least one embodiment, before the first access network device receives the first message sent by the second access network device, the method further includes: The first access network device receives an eleventh message from the first access network device. The eleventh message is usable to indicate the first access network device to request to establish a connection to the second access network device. The first access network device sends an eleventh response message to the second access network device for the eleventh message. The eleventh response message is usable to indicate that the connection to the second access network device is allowed to be established.

In at least one embodiment, the method further includes: The first access network device receives a first configuration message sent by the second access network device. The first configuration message includes configuration information of a data radio bearer (DRB). The first access network device receives, through the DRB, data that is of a first terminal device corresponding to the DRB and that is sent by the second access network device. The first terminal device is any one of the one or more terminal devices.

In at least one embodiment, the method further includes: The first access network device receives a second configuration message sent by the second access network device. The second configuration message includes configuration information of one or more data radio bearers (DRBs). The first access network device receives, through the one or more DRBs, data forwarded by the second access network device. A packet header of the data includes an identifier of a first terminal device and a length of the data, the identifier is usable to indicate that the data is from the first terminal device, and the first terminal device is any one of the one or more terminal devices.

In at least one embodiment, the method further includes: The first access network device receives a seventh message from the second access network device. The seventh message includes a C-RNTI that corresponds to the terminal devices and that is of the first access network device, a C-RNTI that corresponds to the terminal devices and that is of the second access network device, a packet data convergence protocol (PDCP) sequence number of the DRB, and a hyper frame number (HFN).

In at least one embodiment, after the first access network device receives the fifth message sent by the one or more terminal devices, the method further includes: The first access network device sends an eighth message to a core network device. The eighth message is usable to indicate that the one or more terminal devices are handed over to the first access network device. The first access network device receives an eighth response message sent by the core network device for the eighth message.

In at least one embodiment, after the first access network device receives the fifth message sent by the one or more terminal devices, the method further includes: The first access network device sends a ninth message to the second access network device. The ninth message is usable to indicate the second access network device to release context information of the one or more terminal devices.

According to a fifth aspect, at least one embodiment provides a network handover method. The method includes: A second access network device sends a first message to a first access network device. The first message is usable to request to hand over a group of terminal devices under the second access network device to the first access network device, and the group of terminal devices includes one or more terminal devices. In response to the second access network device receiving a first response message from the first access network device for the first message, the second access network device sends a second message to the one or more terminal devices. The first response message is usable to indicate that the one or more terminal devices are allowed to be handed over to the first access network device, and the second message is usable to indicate the terminal devices to be handed over to the first access network device. For beneficial effects of the fifth aspect, refer to the content described in the fourth aspect.

In at least one embodiment, before that a second access network device sends a first message to a first access network device, the method further includes: The second access network device sends a tenth message to the first access network device. The tenth message is usable to indicate the first access network device to switch on one or more cells.

In at least one embodiment, the second message includes dedicated configuration information and common configuration information, the dedicated configuration information includes one or more of the following: random access channel (RACH) configuration information of the one or more terminal devices, or channel state information (CSI) or measurement configuration information of the one or more terminal devices, and the common configuration information includes one or more of the following: physical downlink control channel (PDCCH) configuration information, physical downlink shared channel (PDSCH) configuration information, physical uplink control channel (PUCCH) configuration information, or physical uplink shared channel (PUSCH) configuration information.

In at least one embodiment, a specific implementation in which the second access network device sends the second message to the one or more terminal devices is: The second access network device multicasts the second message to the one or more terminal devices. The second message carries common configuration information, and the common configuration information includes one or more of the following: physical downlink control channel (PDCCH) configuration information, physical downlink shared channel (PDSCH) configuration information, physical uplink control channel (PUCCH) configuration information, or physical uplink shared channel (PUSCH) configuration information. The method further includes: The second access network device unicasts corresponding dedicated configuration information to the one or more terminal devices. The dedicated configuration information includes one or more of the following: random access channel (RACH) configuration information corresponding to the terminal device, or channel state information (CSI) or measurement configuration information of the terminal device.

In at least one embodiment, after the first access network device sends the first message to the second access network device, the method further includes: The second access network device receives an eleventh message from the first access network device. The eleventh message is used to request to establish a connection to the second access network device. The second access network device sends an eleventh response message to the first access network device for the eleventh message. The eleventh response message is usable to indicate that the first access network device is allowed to establish the connection to the second access network device.

In at least one embodiment, the method further includes: The second access network device sends a first configuration message to the first access network device. The first configuration message includes configuration information of a data radio bearer (DRB). The second access network device forwards data of a first terminal device to the first access network device through one or N DRBs corresponding to the first terminal device. The first terminal device is any one of the one or more terminal devices, and N is a positive integer and is greater than 1.

In at least one embodiment, the method further includes: The second access network device sends a second configuration message to the first access network device. The second configuration message includes configuration information of one or more data radio bearers (DRBs). The second access network device forwards data of a first terminal device to the first access network device through the one or more DRBs. A packet header of the data includes an identifier of the first terminal device and a length of the data, and the first terminal device is any one of the one or more terminal devices.

In at least one embodiment, after the second access network device sends the second message to the one or more terminal devices, the second access network device sends a seventh message to the first access network device. The seventh message includes a C-RNTI that corresponds to the terminal devices and that is of the first access network device, a C-RNTI that corresponds to the terminal devices and that is of the second access network device, a packet data convergence protocol (PDCP) sequence number of the DRB, and a hyper frame number (HFN).

In at least one embodiment, the method further includes: The second access network device receives a ninth message from the first access network device. The second access network device releases context information of the one or more terminal devices based on the ninth message.

According to a sixth aspect, at least one embodiment provides a network handover method. The method includes: A terminal device receives a second message sent by a second access network device. The second message is usable to indicate the terminal device to be handed over to a first access network device. The terminal device sends a fifth message to the first access network device. The fifth message is usable to request to be handed over to the first access network device. For beneficial effects of the sixth aspect, refer to the content described in the third aspect.

In at least one embodiment, the second message includes dedicated configuration information and common configuration information, the dedicated configuration information includes one or more of the following: random access channel (RACH) configuration information of one or more terminal devices, or channel state information (CSI) or measurement configuration information of the one or more terminal devices, and the common configuration information includes one or more of the following: physical downlink control channel (PDCCH) configuration information, physical downlink shared channel (PDSCH) configuration information, physical uplink control channel (PUCCH) configuration information, or physical uplink shared channel (PUSCH) configuration information.

In at least one embodiment, the second message carries common configuration information, and the common configuration information includes one or more of the following: physical downlink control channel (PDCCH) configuration information, physical downlink shared channel (PDSCH) configuration information, physical uplink control channel (PUCCH) configuration information, or physical uplink shared channel (PUSCH) configuration information. The method further includes: The terminal device receives dedicated configuration information sent by the second access network device. The dedicated configuration information includes one or more of the following: random access channel (RACH) configuration information corresponding to the terminal device, or channel state information (CSI) or measurement configuration information of the terminal device.

According to a seventh aspect, at least one embodiment provides a communication apparatus. The apparatus is a first access network device, or is an apparatus in the first access network device, or an apparatus that is used together with the first access network device. The communication apparatus is alternatively a chip system. The communication apparatus performs the method according to the first aspect or the fourth aspect. A function of the communication apparatus is implemented by hardware, or is implemented by hardware executing corresponding software. The hardware or the software includes one or more units or modules corresponding to the foregoing functions. The unit or the module is software and/or hardware. For operations performed by the communication apparatus and beneficial effects thereof, refer to the method according to the first aspect or the fourth aspect, and the beneficial effects thereof. Repeated content is not described again.

According to an eighth aspect, at least one embodiment provides a communication apparatus. The apparatus is a second access network device, or is an apparatus in the second access network device, or an apparatus that is used together with the second access network device. The communication apparatus is alternatively a chip system. The communication apparatus performs the method according to the second aspect or the fifth aspect. A function of the communication apparatus is implemented by hardware, or is implemented by hardware executing corresponding software. The hardware or the software includes one or more units or modules corresponding to the foregoing functions. The unit or the module is software and/or hardware. For operations performed by the communication apparatus and beneficial effects thereof, refer to the method according to the second aspect or the fifth aspect, and the beneficial effects thereof. Repeated content is not described again.

According to a ninth aspect, at least one embodiment provides a communication apparatus. The apparatus is a terminal device, or is an apparatus in the terminal device, or an apparatus that is used together with the terminal device. The communication apparatus is alternatively a chip system. The communication apparatus performs the method according to the third aspect or the sixth aspect. A function of the communication apparatus is implemented by hardware, or is implemented by hardware executing corresponding software. The hardware or the software includes one or more units or modules corresponding to the foregoing functions. The unit or the module is software and/or hardware. For operations performed by the communication apparatus and beneficial effects thereof, refer to the method according to the third aspect or the sixth aspect, and the beneficial effects thereof. Repeated content is not described again.

According to a tenth aspect, at least one embodiment provides a communication apparatus. The communication apparatus includes a processor. In response to the processor invoking a computer program in a memory, the method according to any one of the first aspect to the sixth aspect is performed.

In at least one embodiment, the communication apparatus further includes the memory, and the memory and the processor are coupled to each other. Optionally, the memory and the processor are integrated together.

In at least one embodiment, the communication apparatus further includes a transceiver, and the transceiver is configured to send and receive data and/or signaling.

According to an eleventh aspect, at least one embodiment provides a communication apparatus. The communication apparatus includes a processor and an interface circuit. The interface circuit is configured to receive a signal from a communication apparatus other than the communication apparatus and transmit the signal to the processor or send a signal from the processor to a communication apparatus other than the communication apparatus. The processor is configured to implement the method according to any one of the first aspect to the sixth aspect by using a logic circuit or by executing code instructions.

According to a twelfth aspect, at least one embodiment provides a computer-readable storage medium. The storage medium stores a computer program or instructions. In response to the computer program or the instructions being executed by a communication apparatus, the method according to any one of the first aspect to the sixth aspect is implemented.

According to a thirteenth aspect, an embodiment of at least one embodiment provides a computer program or a computer program product, including code or instructions. In response to the code or the instructions being run on a computer, the computer is enabled to perform the method according to any one of the first aspect to the sixth aspect.

According to a fourteenth aspect, an embodiment of at least one embodiment provides a communication system. The system includes the communication apparatuses provided in the seventh aspect, the eighth aspect, and the ninth aspect.

### BRIEF DESCRIPTION OF DRAWINGS

FIG. 1 is a schematic diagram of a communication structure according to at least one embodiment;

FIG. 2 is a schematic diagram of a communication system according to at least one embodiment:

FIG. 3 is a schematic interaction diagram of a network handover method according to at least one embodiment:

FIG. 4 is a schematic interaction diagram of another network handover method according to at least one embodiment:

FIG. 5 is a schematic interaction diagram of another network handover method according to at least one embodiment:

FIG. 6 is a schematic diagram of a structure of a communication apparatus according to at least one embodiment:

FIG. 7 is a schematic diagram of a structure of another communication apparatus according to at least one embodiment; and

FIG. 8 is a schematic diagram of a structure of a chip according to at least one embodiment.

### DESCRIPTION OF EMBODIMENTS

The following further describes at least one embodiment in detail with reference to accompanying drawings.

The terms “first”, “second”, and the like in at least one embodiment, claims, and accompanying drawings are used to distinguish between different objects, but are not used to describe a specific sequence. In addition, the terms “including” and “having” and any other variants thereof are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

Mentioning an “embodiment” herein means that a particular characteristic, structure, or feature described herein is included in at least one embodiment. The phrase shown in various locations herein does not necessarily refer to a same embodiment, and is not an independent or optional embodiment exclusive from another embodiment. Persons skilled in the art understand that embodiments described herein are combined with another embodiment.

In at least one embodiment, “at least one (item)” means one or more, “a plurality of” means two or more, “at least two (items)” means two, three, or more, and “and/or” is used to describe a correspondence between associated objects and indicates that three relationships exist. For example, “A and/or B” is usable to indicate the following three cases: Only A exists, only B exists, and both A and B exist, where A and B is singular or plural. The character “/” generally indicates an “or” relationship between the associated objects. The expression “at least one of the following items (pieces)” or a similar expression means any combination of these items, including a single item (piece) or any combination of a plurality of items (pieces). For example, at least one of a, b, or c indicates a, b, c, “a and b”, “a and c”, “b and c”, or “a, b, and c”, where a, b, and c is singular or plural.

At least one embodiment provides a network handover method. The following first describes professional terms in embodiments described herein.

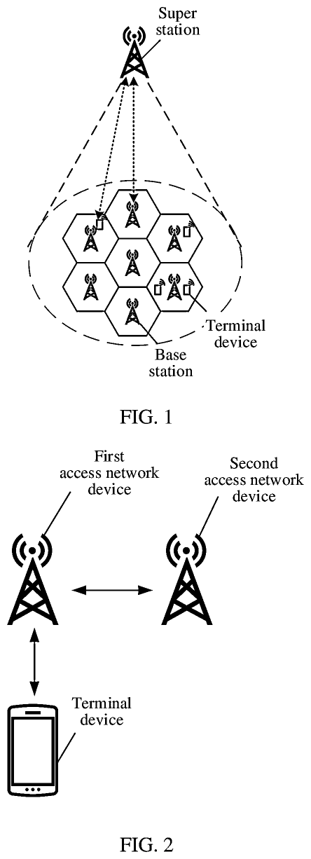

Super station: The super station is an access network device that manages and controls one or more base stations, and also has a function of providing a network service for a terminal device. As shown in FIG. 1, one super station, seven base stations, and a plurality of terminal devices are included in FIG. 1. The super station has functions of providing network services for the terminal devices and managing and controlling the seven base stations, for example, switching off a base station or handing over some terminal devices to a corresponding base station. A terminal device in a network area covered by the super station accesses the super station, to obtain a network service by using the super station, or accesses a base station under the super station. The super station is a satellite, a stratospheric communication high-tower (a balloon, an uncrewed aerial vehicle, or an airship), a high-power high-tower (like a radio and television tower), a medium-power medium-tower (where a station height and transmit power are between those of an existing base station and those of the radio and television tower), or the like. The super station and the base station perform transmission through an optical fiber or wirelessly.

The following describes a system architecture in at least one embodiment.

To facilitate understanding of technical solutions in at least one embodiment, the following briefly describes a system architecture of a method provided in at least one embodiment. The system architecture described herein is intended to describe the technical solutions in at least one embodiment more clearly, and does not constitute any limitation on the technical solutions provided in at least one embodiment.

The technical solutions in at least one embodiment are applied to various communication systems, for example, a satellite communication system and a terrestrial mobile communication system. The satellite communication system is integrated with the terrestrial communication system. For example, the communication systems are a wireless local area network (WLAN) communication system, a long term evolution (LTE) system, or a 5th generation (5G) communication system like a new radio (NR) communication system, a wireless fidelity (Wi-Fi) system, a communication system evolved after 5G, for example, a 6th generation (6G) communication system, another future communication system, and the like. A communication system in which a plurality of wireless technologies are integrated is further supported. For example, the technical solutions are also applied to a system in which a non-terrestrial network (NTN) is integrated with a terrestrial mobile communication network, for example, an uncrewed aerial vehicle, a satellite communication system, or a high altitude platform station (HAPS) communication system.

FIG. 2 is a schematic diagram of a communication system applicable to at least one embodiment. The communication system includes at least one access network device and at least one terminal device. Refer to FIG. 2. There is one terminal device and two access network devices (a first access network device and a second access network device). The terminal device is connected to the first access network device, or is connected to the second access network device. The first access network device and the second access network device also maintain communication. Certainly, a quantity of devices in FIG. 2 is merely an example. This is not limited in at least one embodiment.

The access network device in at least one embodiment is a device configured to communicate with the terminal device, or is a device for enabling the terminal device to access a wireless network. The access network device is a node in a radio access network and is also referred to as a base station or a radio access network (RAN) node (or device). For example, the base station in at least one embodiment includes base stations in various forms, for example, a macro base station, a micro base station (also referred to as a small cell), a relay station, an access point, an evolved NodeB (eNB or eNodeB) in LTE, a next generation NodeB (gNodeB, gNB) in a 5G network, a broadband network gateway (BNG), an aggregation switch or a non-3rd generation partnership project (3GPP) access device, a transmission reception point (TRP), a transmission point (TP), a mobile switching center, a home base station (for example, a home evolved NodeB, or home NodeB, HNB), a baseband unit (BBU), a baseband unit pool (BBU pool), a Wi-Fi access point (AP), a central unit (CU) and a distributed unit (DU) in a cloud radio access network (C-RAN), an integrated access and backhaul (IAB) node, and a device having a base station function in communication systems evolved after 5G, such as device-to-device (D2D), vehicle-to-everything (V2X), machine-to-machine (M2M), internet of things (IoT), and 6G communication systems. In addition, the access network device is alternatively the super station described above, and has functions of managing one or more base stations and providing the network service for the terminal device. This is not specifically limited in at least one embodiment.

The access network device communicates and interacts with a core network device, and provide a communication service for the terminal device. The core network device is a device in a core network (CN) of a 5G network, or a core network device in a communication system evolved after 5G, for example, a 6G communication system. As a bearer network, the core network provides an interface to a data network, provides communication connection, authentication, management, and policy control for user equipment (UE), bears a data service, and the like. The access network device is connected to the core network device in a wireless or wired manner. The core network device and the access network device are different physical devices that are independent of each other: or functions of the core network device and logical functions of the access network device are integrated into a same physical device: or some functions of the core network device and some functions of the access network device are integrated into a same physical device.

The terminal device mentioned in at least one embodiment is a device having a wireless transceiver function, and is specifically UE, an access terminal, a subscriber unit, a subscriber station, a mobile station, a remote station, a remote terminal, a mobile device, a user terminal, a wireless communication device, a user agent, or a user apparatus. Alternatively, the terminal device is a satellite phone, a cellular phone, a smartphone, a wireless data card, a wireless modem, a machine type communication device, a cordless phone, a session initiation protocol (SIP) phone, a wireless local loop (WLL) station, a personal digital assistant (PDA), a handheld device having a wireless communication function, a computing device, another processing device connected to the wireless modem, a vehicle-mounted device, a communication device carried on a high-altitude aircraft, a wearable device, an unmanned aerial vehicle, a robot, a terminal in D2D, a terminal in V2X, a virtual reality (VR) terminal device, an augmented reality (AR) terminal device, a wireless terminal in industrial control, a wireless terminal in self driving, a wireless terminal in telemedicine, a wireless terminal in a smart grid, a wireless terminal in transportation safety, a wireless terminal in a smart city, a wireless terminal in a smart home, a terminal device in a future communication network, or the like. This is not limited in at least one embodiment.

In addition, in at least one embodiment, the terminal device is an apparatus configured to implement a function of a terminal, or is an apparatus, for example, a chip system, that supports the terminal device in implementing the function. The apparatus is mounted in the terminal device. For example, the terminal device is alternatively a vehicle detector or a sensor in a gas station.

To meet people's increasing traffic usage, wireless networks are constantly under rapid construction. As a network scale increases, network energy consumption on a base station side increases continuously, and expenditure of electricity fees greatly increases costs of an operator. A main reason for an increase in the energy consumption on the base station side mainly includes: large-scale commercial use of an active antenna unit (AAU), and a significant increase in a quantity of antennas on the base station side. In order to support higher data rates and larger traffic, transmission bandwidth of a wireless network is increased. Millimeter wave and terahertz embodiments enable site deployment to be dense.

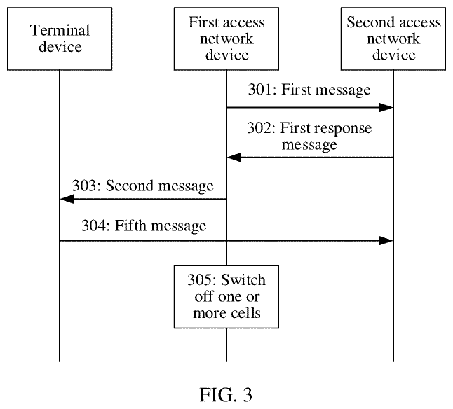

To reduce energy consumption of an access network device, at least one embodiment provides a network handover method. FIG. 3 is a schematic interaction diagram of a network handover method according to at least one embodiment. As shown in FIG. 3, the network handover method includes step 301 to step 305. For brief representation, only one terminal device is shown in FIG. 3. There are one or more terminal devices. This is not limited in at least one embodiment. Execution bodies of the method shown in FIG. 3 are a terminal device, a first access network device, and a second access network device. Alternatively, execution bodies of the method shown in FIG. 3 are chips in a terminal device, a first access network device, and a second access network device. In FIG. 3, an example in which the execution bodies are the terminal device, the first access network device, and the second access network device is used for description. Execution bodies of subsequent figures are similar, and details are not described herein again.

301: The first access network device sends a first message to the second access network device. Correspondingly, the second access network device receives the first message sent by the first access network device.

In at least one embodiment, the first access network device is the first access network device in the communication system shown in FIG. 2, and the second access network device is the second access network device in the communication system shown in FIG. 2. The first message is usable to request to hand over a group of terminal devices under the first access network device to the second access network device. The handover is also described as migration. The first message is usable to request to migrate the group of terminal devices under the first access network device to the second access network device. The group of terminal devices includes one or more terminal devices. The one or more terminal devices are connected to the first access network device and camp on one or more cells served by the first access network device. The terminal device is the terminal device in the communication system shown in FIG. 2.

Optionally, the first message is a handover request message. The first message carries information about the one or more terminal devices, specifically including: a cell-radio network temporary identifier (C-RNTI) that corresponds to the terminal device and that is of the first access network device and/or an access stratum (AS) configuration of the terminal device. The AS configuration includes one or more of the following information: antenna information, a downlink carrier frequency, information about a correspondence between quality of service (QOS) and a data radio bearer (DRB), capability information of the terminal device, and protocol data unit (PDU) session related information.

In at least one embodiment, the first access network device is a common cellular station and has a function of providing a network service for the terminal device. The second access network device is a super station and manages and controls the first access network device, and also has a function of providing a network service for the terminal device.

In at least one embodiment, the first message is further usable to request to switch off one or more cells. The one or more terminal devices camp on the one or more cells. In response to a quantity of terminal devices under the first access network device being small or power of the first access network device being insufficient, to reduce energy consumption of the first access network device, the first access network device requests, by using the first message, to hand over the group of terminal devices under the first access network device to the second access network device, and then switch off the one or more cells. The first access network device switches off the one or more cells in the following two manners. One manner is to switch off all cells served by the first access network device, that is, switch off the first access network device. The other manner is to switch off some cells served by the first access network device. The switching off the first access network device or the switching off some cells served by the first access network device is understood as enabling the first network device or the cells served by the first access network device to sleep, or is understood as deactivating the first access network device or the cells served by the first access network device. This is not specifically limited herein. Based on this implementation, the one or more terminal devices is handed over to the second access network device, without reducing networking service experience of the terminal device, and the first access network device switches off the one or more cells. This helps reduce the energy consumption of the first access network device.

A specific implementation of switching off the first access network device is any one of the following manners: switching off a power amplifier (PA) of the first access network device; switching off a PA and a radio frequency component of the first access network device, where the radio frequency component includes an intermediate frequency component, a small signal processing component, and the like: switching off a PA, a radio frequency component, and a main device of the first access network device, where the main device includes devices such as a baseband board and a main control board: or switching off a PA, a radio frequency component, a main device, an air conditioner module, and a power module of the first access network device.

Optionally, the first message carries a switch-off request message. The switch-off request message carries the following one or more types of identifiers: an identifier of one or more cells, an identifier of one or more radio access technologies (RATs), an identifier of one or more sectors, and an identifier of one or more TRPs. In response to the second access network device determining that the received first message includes the switch-off request message, the second access network device determines that the first access network device is to switch off the one or more cells. This implementation helps the second access network device learn of a switch-off manner requested by the first access network device and better manage the first access network device.

Optionally, information about the group of terminal devices in the first message implicitly indicates the switch-off request message. In response to the second access network device determining that the first message includes the information about the group of terminal devices, the second access network device determines that the first access network device requests to switch off the one or more cells. Information about a terminal device refers to an identifier of the terminal device at an interface of a node of the first access network device, where the identifier identifies the terminal device at an interstation interface of the node: or refer to an identifier of the terminal device at an interface of a node of the second access network device: or refer to a C-RNTI that corresponds to the terminal device and that is of the first access network device and/or a C-RNTI that corresponds to the terminal device and that is of the second access network device. This implementation reduces overheads usable for sending the first message.

In at least one embodiment, before the first access network device sends the first message to the second access network device, the method further includes: The first access network device sends an eleventh message to the second access network device. The eleventh message is usable to request to establish a connection to the second access network device. The second access network device sends an eleventh response message to the first access network device for the eleventh message. The eleventh response message is usable to indicate that the first access network device is allowed to establish the connection to the second access network device. The eleventh message is a connection setup request message, and the eleventh message includes an identifier of the first access network device. Optionally, the eleventh message further includes one or more of the following: serving cell information and neighboring cell information of different RATs under the first access network device, and further includes information such as a tracking area supported by the first access network device, and an access and mobility management area to which the first access network device belongs. The eleventh response message is a connection setup response message. The eleventh response message includes an identifier of the second access network device, serving cell information and neighboring cell information of different RATs under the second access network device, and optionally, further includes a tracking area supported by the second access network device.

Optionally, before the first access network device sends the first message to the second access network device, the first access network device sends a thirteenth message to the one or more terminal devices. After receiving the thirteenth message, the terminal device sends a thirteenth response message to the first access network device. The thirteenth message is usable to indicate the terminal device to measure a signal of a neighboring cell, the thirteenth message includes measurement control information of the neighboring cell, and the thirteenth response message is usable to indicate that the thirteenth message has been received. Optionally, the thirteenth message is an RRC reconfiguration (e.g. RRC Reconfiguration) message, and the thirteenth response message is an RRC reconfiguration complete (e.g. RRC ReconfigurationComplete) message. After measuring the signal of the neighboring cell, the terminal device sends a measurement report to the first access network device. The measurement report includes a measurement result of the neighboring cell.

302: The second access network device sends a first response message to the first access network device. Correspondingly, the first access network device receives the first response message sent by the second access network device.

In at least one embodiment, after the second access network device receives the first message, in response to the second access network device determining that handing over the one or more terminal devices under the first access network device to the second access network device is accepted, the second access network device sends the first response message to the first access network device for the first message. The first response message is usable to indicate that the one or more terminal devices are allowed to be handed over to the second access network device. Optionally, the first response message is a handover request response (e.g. Handover Request Acknowledge) message. The first response message includes radio resource control (RRC) configuration information corresponding to the one or more terminal devices. The RRC configuration information includes one or more of the following: a C-RNTI that corresponds to the terminal devices and that is of the second access network device, a target cell identifier, a security identifier, or random access channel (RACH) information corresponding to the terminal devices. The target cell identifier is an identifier of a cell on which the terminal devices are to camp under the second access network device. The security identifier is a related parameter in an encryption algorithm, or is an encryption key, or is a parameter usable in an integrity protection algorithm, or the like. This is not limited in at least one embodiment.

In at least one embodiment, in response to the first message further indicating to request to switch off the one or more cells, the first response message further indicates that the one or more cells are allowed to be switched off. Based on this implementation, the first access network device switches off the one or more cells, which helps reduce energy consumption of the first access network device. In addition, the one or more terminal devices are also handed over to the second access network device, without reducing network service experience of the terminal device.

Optionally, in response to the first message carrying the switch-off request message, the first response message carries switch-off response information. The switch-off response information is usable to indicate a cell that is allowed to be switched off by the first access network device or the like, and the switch-off response information includes one or more of the following identifiers: an identifier of the one or more cells, an identifier of one or more RATs, an identifier of one or more sectors, and an identifier of one or more TRPs. For example, in response to the first access network device sending the first message to the second access network device, where the first message carries identifiers of a cell 1 and a cell 2, indicating that the cell 1 and the cell 2 are expected to be switched off, the second access network device determines, based on a status of the second access network device, that only a terminal device corresponding to the cell 1 is accepted and a terminal device corresponding to the cell 2 cannot be accepted. The first response message sent by the second access network device includes only the identifier of the cell 1, indicating that only the cell 1 is allowed to be switched off by the first access network device. In addition, the switch-off response information is alternatively merely acknowledge information, indicating that all cells carried in the first message are switched off. This implementation helps the second access network device better manage the first access network device.

Optionally, information about the group of terminal devices in the first response message implicitly indicates the switch-off response information. In response to the first access network device determining that the first response message includes the information about the group of terminal devices, the first access network device determines that the second access network device allows to switch off the one or more cells. Information about a terminal device refers to an identifier of the terminal device at an interface of a node of the first access network device, where the identifier identifies the terminal device at an interstation interface of the node; or refer to an identifier of the terminal device at an interface of a node of the second access network device: or refer to a C-RNTI that corresponds to the terminal device and that is of the first access network device and/or a C-RNTI that corresponds to the terminal device and that is of the second access network device. This implementation reduces overheads usable for sending the first response message.

In at least one embodiment, after the first access network device sends the first message to the second access network device, the method further includes: The first access network device starts a timer. In response to the timer expiring and the first access network device does not receive the first response message, the first access network device sends a sixth message to the second access network device. The sixth message is usable to indicate to cancel the handover of the one or more terminal devices. The sixth message is a handover cancel message. The handover cancel message includes any one or more of the following information: a C-RNTI that corresponds to the one or more terminal devices and that is of the first access network device, a C-RNTI that corresponds to the one or more terminal devices and that is of the second access network device, a handover cancellation reason, or target cell information. Optionally, timing duration of the timer is determined based on a type of the second access network device. The type of the second access network device is a satellite, a stratospheric communication high-tower (a balloon, an uncrewed aerial vehicle, or an airship), a high-power high-tower (like a radio and television tower), a medium-power medium-tower (a station height and transmit power are between those of an existing base station and those of the radio and television tower), or the like. Duration usable by access network devices of different types to receive the first message is different, and corresponding timer duration matches the type of the second access network device. This helps avoid a terminal device handover failure caused by an inappropriate setting of the timer duration. This implementation helps avoid waiting for the first response message of the second access network device for long time.

In at least one embodiment, in response to the second access network device not being able to hand over the one or more terminal devices to the second access network device because load of a network bearer is large, or the second access network device cannot meet a quality of service QoS of the one or more terminal devices, or the like, the second access network device sends a first response message to the first access network device. The first response message is usable to indicate that the one or more terminal devices are not allowed to be handed over to the second access network device. Based on this implementation, the second access network device determines, based on a status of the second access network device, whether to accept access of the one or more terminal devices, to avoid a case that the second access network device is overloaded.

303: The first access network device sends a second message to a terminal device. Correspondingly, the terminal device receives the second message sent by the first access network device.

In at least one embodiment, the terminal device described herein is one terminal device or is a plurality of terminal devices. A quantity of terminal devices herein is not limited in at least one embodiment. The second message is usable to indicate the terminal device to be handed over to the second access network device. Optionally, the second message is an RRC reconfiguration message.

In at least one embodiment, a specific implementation of step 303 is: The first access network device multicasts the second message to the one or more terminal devices. The second message includes dedicated configuration information and common configuration information. The dedicated configuration information includes one or more of the following information: RACH configuration information of the one or more terminal devices, channel state information (CSI) or measurement configuration information of the one or more terminal devices, a new identifier of the one or more terminal devices, a UE-specific physical downlink control channel (PDCCH) configuration of the one or more terminal devices, a UE-specific physical downlink shared channel (PDSCH) configuration of the one or more terminal devices, another UE-specific configuration shown in spCellConfigDedicated in the protocol TS 38.331, and the like. This is not limited in at least one embodiment. The common configuration information includes one or more of the following information: cell-specific PDCCH configuration information, cell-specific PDSCH configuration information, cell-specific physical uplink control channel (PUCCH) configuration information, cell-specific physical uplink shared channel (PUSCH) configuration information, a physical cell identifier of the second access network device, and another cell-specific configuration shown in ServingCellConfigCommon in the protocol TS 38.331. This is not limited in at least one embodiment. Based on this implementation, a second message received by each terminal device is the same. For example, the second message includes common configuration information, dedicated configuration information 1, dedicated configuration information 2, . . . , and dedicated configuration information n. The dedicated configuration information 1 corresponds to a first terminal device, the dedicated configuration information 2 corresponds to a second terminal device, and both the first terminal device and the second terminal device are devices in the group of terminal devices. After the first terminal device receives the second message, the first terminal device determines, from the second message, the dedicated configuration information 1 corresponding to the first terminal device and the common configuration information. In a multicast manner, one message carries information about a plurality of terminal devices. This avoids repeated sending of a common configuration, and helps reduce signaling overheads.

Optionally, before the first access network device multicasts the second message to the one or more terminal devices, the first access network device sends reconfiguration related information to the one or more terminal devices in advance. The reconfiguration related information is usable to help the terminal devices parse content in the second message. The reconfiguration related information includes any one or more of the following information: an encryption algorithm for the second message, a key corresponding to the second message, and a radio network temporary identifier (RNTI). The method improves security of the second message.

In at least one embodiment, a specific implementation of step 303 is: The first access network device multicasts the second message to the one or more terminal devices. The second message carries common configuration information. The common configuration information includes one or more of the following information: cell-specific PDCCH configuration information, cell-specific PDSCH configuration information, cell-specific PUCCH configuration information, cell-specific PUSCH configuration information, a physical cell identifier of the second access network device, and another cell-specific configuration shown in ServingCellConfigCommon in the protocol TS 38.331. This is not limited in at least one embodiment. The method further includes: The first access network device unicasts corresponding dedicated configuration information to the one or more terminal devices. The dedicated configuration information includes one or more of the following information: RACH configuration information of the one or more terminal devices, CSI or measurement configuration information of the one or more terminal devices, a new identifier of the one or more terminal devices, a UE-specific PDCCH configuration of the one or more terminal devices, a UE-specific PDSCH configuration of the one or more terminal devices, another UE-specific configuration shown in spCellConfigDedicated in the protocol TS 38.331, and the like. This is not limited in at least one embodiment. Based on this implementation, the first access network device sends the common configuration information in a multicast manner and sends the dedicated configuration information in a unicast manner. The dedicated configuration information received by the terminal devices includes only the configuration information usable by the terminal devices and has high security.

304: The terminal device sends a fifth message to the second access network device. Correspondingly, the second access network device receives the fifth message sent by the terminal device.

In at least one embodiment, the fifth message is usable to indicate that the terminal device requests to be handed over to the second access network device. Optionally, the fifth message is an RRC reconfiguration complete (RRC ReconfigurationComplete) message. The fifth message includes any one or more of the following information: an RRC transaction identifier. There are one or more terminal devices described herein. This is not limited in at least one embodiment.

305: The first access network device switches off one or more cells.

In at least one embodiment, after the one or more terminal devices are handed over to the second access network device, the first access network device switches off the one or more cells. That the first access network device switches off the one or more cells means that the first access network device switches off the one or more cells in the following two manners. One manner is to switch off all cells served by the first access network device, that is, switch off the first access network device. The other manner is to switch off some cells served by the first access network device. For a specific implementation, refer to the descriptions in step 301. Details are not described again in at least one embodiment.

A method for determining, by the first access network device, that the one or more terminal devices are handed over to the second access network device includes the following implementations.

In at least one embodiment, the first access network device sends a fourth message to the second access network device. The fourth message is usable to indicate that the first access network device is to switch off the one or more cells. The first access network device receives a fourth response message from the second access network device for the fourth message. The fourth response message is usable to indicate that the one or more cells are allowed to be switched off. In response to receiving the fourth response message, the first access network device determines that the one or more terminal devices have been handed over to the second access network device.

In at least one embodiment, the first access network device sends a fourth message to the second access network device. The fourth message is usable to indicate that the first access network device is to switch off the one or more cells. After waiting a preset time length, the first access network device switches off the one or more cells.

In at least one embodiment, after the first access network device sends the second message to the one or more terminal devices, after waiting a preset time length, the first access network device considers that the one or more terminal devices are handed over to the second access network device. The first access network device sends a fourth message to the second access network device. The fourth message is usable to indicate that the first access network device is to switch off the one or more cells. After the first access network device sends the fourth message, the first access network device switches off the one or more cells.

In at least one embodiment, the first access network device receives a twelfth message from the second access network device. The twelfth message is usable to indicate the first access network device to switch off the one or more cells. In response to receiving the twelfth message, the first access network device determines that the one or more terminal devices have been handed over to the second access network device.

In addition to the foregoing described embodiments, the first access network device further determines, in another manner, that the one or more terminal devices have been handed over to the second access network device. This is not limited in at least one embodiment.

Based on the foregoing described network handover method, the first access network device uniformly hands over a plurality of terminal devices to the second access network device and then switches off the cells. The cells are switched off without waiting for a case that the plurality of terminal devices are handed over to another access network device. This helps reduce energy consumption of the first access network device.

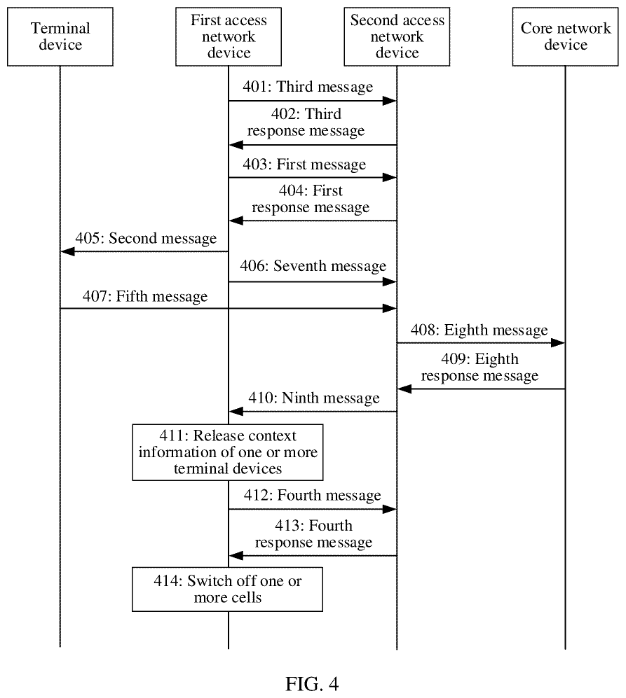

FIG. 4 is a schematic interaction diagram of another network handover method according to at least one embodiment. As shown in FIG. 4, the network handover method includes step 401 to step 414. For brief representation, only one terminal device is shown in FIG. 4. There are one or more terminal devices. This is not limited in at least one embodiment.

401: A first access network device sends a third message to a second access network device. Correspondingly, the second access network device receives the third message sent by the first access network device.

In at least one embodiment, the third message is usable to request to switch off one or more cells. The third message includes the following one or more types of identifiers: an identifier of the one or more cells, an identifier of one or more RATs, an identifier of one or more sectors, and an identifier of one or more TRPs.

402: The second access network device sends a third response message to the first access network device. Correspondingly, the first access network device receives the third response message sent by the second access network device.

In at least one embodiment, the third response message is usable to indicate that the one or more cells are allowed to be switched off. The third response message includes the following one or more types of identifiers: the identifier of the one or more cells, the identifier of the one or more RATs, the identifier of the one or more sectors, and the identifier of the one or more TRPs. The second access network device manages, based on the third response message, whether to switch off the cells served by the first access network device. For example, in response to the first access network device sending the third message to the second access network device, where the third message carries identifiers of a cell 1 and a cell 2, the second access network device determines, based on an actual status, that only the cell 1 is allowed to be switched off and the cell 2 cannot be switched off. The third response message sent by the second access network device to the first access network device includes only the identifier of the cell 1. The first access network device cannot switch off the cell 2.

Optionally, the third response message alternatively carries only acknowledge information, indicating that the one or more cells indicated in the third message are allowed to be switched off. This implementation reduces network overheads usable for sending the third response message.

403: The first access network device sends a first message to the second access network device. Correspondingly, the second access network device receives the first message sent by the first access network device.

404: The second access network device sends a first response message to the first access network device. Correspondingly, the first access network device receives the first response message sent by the second access network device.

Specific implementations of step 403 and step 404 are the same as the specific implementations of step 301 and step 302. Details are not described again in at least one embodiment.

In at least one embodiment, in response to the first message further indicating to request to switch off the one or more cells, and the first response message further is usable to indicate that the one or more cells are allowed to be switched off, step 401 and step 402 is not performed. This implementation helps reduce network overheads.

The first message and the third message are a same message. For example, the first message and the third message are represented by using a first message. The first message is usable to indicate to request to hand over a group of terminal devices and to request to switch off the one or more cells. The first response message and the third response message are alternatively a same message. For example, the first response message and the third response message are represented by using a first response message. The first response message is usable to indicate that handover of a group of terminal devices is allowed and the one or more cells are allowed to be switched off.

405: The first access network device sends a second message to a terminal device. Correspondingly, the terminal device receives the second message sent by the first access network device.

A specific implementation of step 405 is the same as the specific implementation of step 303. Details are not described again in at least one embodiment.

406: The first access network device sends a seventh message to the second access network device. Correspondingly, the second access network device receives the seventh message sent by the first access network device.

In at least one embodiment, the seventh message includes one or more of the following: a C-RNTI that corresponds to the terminal device and that is of the first access network device, a C-RNTI that corresponds to the terminal device and that is of the second access network device, a packet data convergence protocol (PDCP) sequence number of a DRB, and a hyper frame number (HFN). Optionally, the seventh message is a sequence number status transfer (SN Status Transfer) message. After receiving the second message sent by the first access network device, the terminal device starts to perform network handover. However, before the terminal device completes handover, the terminal device still transmits a part of service data to the first access network device, and the first access network device forwards this part of service data to the second access network device for processing. Optionally, in response to receiving service data sent by the terminal device, the first access network device forwards the service data to the second access network device. The second access network device receives, based on the seventh message, the service data sent by the first access network device, and processes the service data. The seventh message is usable to determine a data packet marker during data forwarding, to ensure sequential transmission of data and prevent a data loss.

In at least one embodiment, transmission between the first access network device and the second access network device is performed in an air interface manner. In a data forwarding phase, a corresponding DRB is to be established to bear corresponding user data. Specifically, the following two types of DRBs are established.

In an implementation, the second access network device sends a first configuration message to the first access network device. The first configuration message includes configuration information of a data radio bearer (DRB). The first access network device forwards data of a first terminal device to the second access network device through one or N DRBs corresponding to the first terminal device. The first terminal device is any one of the one or more terminal devices, and N is a positive integer and is greater than 1. In this implementation, one terminal device corresponds to one or N DRBs. The second access network device determines, through the DRB, a terminal device from which the data comes. Based on this implementation, different services are provided for different terminal devices. For example, a terminal device with a higher priority corresponds to a larger quantity of DRBs.

Optionally, in response to the second access network device receiving the third message sent by the first access network device, the second access network device sends a second configuration message to the first access network device after receiving the third message from the first access network device, to establish a DRB between the second access network device and the first access network device.

Optionally, in response to the first access network device not sending the third message, but is usable to indicate, by using the first message, to request to switch off the one or more cells, the second access network device sends a second configuration message to the first access network device after receiving the first message from the first access network device.

A sending moment of the second configuration message is further determined based on another factor, for example, a sending moment of a message other than the third message and the first message. This is not limited in at least one embodiment.

In another implementation, the second access network device sends a second configuration message to the first access network device. The second configuration message includes configuration information of one or more data radio bearers (DRBs). The first access network device forwards data of a first terminal device to the second access network device through the one or more DRBs. A packet header of the data includes an identifier of the first terminal device and a length of the data, and the first terminal device is any one of the one or more terminal devices. In this implementation, a DRB corresponding to each terminal device is the same. The second access network device determines, based on a packet header of a data, a terminal device from which the data comes. Based on this implementation, establishing the DRB is more convenient.

Optionally, after a connection is established between the second access network device and the first access network device, the second access network device sends the second configuration message to the first access network device, to establish a DRB between the second access network device and the first access network device.

407: The terminal device sends a fifth message to the second access network device. Correspondingly, the second access network device receives the fifth message sent by the terminal device.

A specific implementation of step 407 is the same as the specific implementation of step 304. Details are not described again in at least one embodiment.

408: The second access network device sends an eighth message to a core network device. Correspondingly, the core network device receives the eighth message sent by the second access network device.

In at least one embodiment, after the second access network device receives the fifth message sent by the one or more terminal devices, the second access network device sends the eighth message to the core network device. The eighth message is usable to indicate that the one or more terminal devices are handed over to the second access network device. The eighth message is a path switch request (e.g. Path switch request) message, and the message includes an identifier of the one or more terminal devices. The eighth message enables the core network device to determine a current connection status of the terminal device, so that an appropriate path is planned for the terminal device and a better network service is provided during subsequent transmission of data related to the terminal device. Optionally, the core network device is an access and mobility management function (AMF) device. In addition, the core network device is alternatively a core network device in a communication system evolved after 5G or 6G. This is not limited in at least one embodiment.

409: The core network device sends an eighth response message to the second access network device. Correspondingly, the second access network device receives the eighth response message sent by the core network device.

In at least one embodiment, the eighth response message is a response message of the core network device for the eighth message, and is usable to indicate that the core network device has updated information corresponding to the one or more terminal devices. The eighth response message is a path switch request response (e.g. Path switch Request Acknowledge) message. The message includes related information of the one or more terminal devices.

410: The second access network device sends a ninth message to the first access network device. Correspondingly, the first access network device receives the ninth message sent by the second access network device.

In at least one embodiment, the ninth message is usable to indicate the first access network device to release context information of the one or more terminal devices. Optionally, the ninth message is a terminal context release (UEContextRelease) message. The ninth message includes identification information of the one or more terminal devices.

411: The first access network device releases context information of one or more terminal devices.

In at least one embodiment, after the first access network device receives the ninth message from the second access network device, the first access network device determines that the one or more terminal devices have been handed over to the second access network device, and therefore releases the context information of the one or more terminal devices. Therefore, storage space of the first access network device is saved.

412: The first access network device sends a fourth message to the second access network device. Correspondingly, the second access network device receives the fourth message sent by the first access network device.

413: The second access network device sends a fourth response message to the first access network device. Correspondingly, the first access network device receives the fourth response message sent by the second access network device.

In at least one embodiment, the fourth message is a switch-off notification (e.g. SwitchOff Notification) message, and the message includes an identifier of one or more cells. The fourth response message is a switch-off notification response (e.g. Notification ACK) message, and the message includes the identifier of the one or more cells.

In at least one embodiment, after the first access network device sends a fourth message, the first access network device switches off one or more cells. After the second access network device receives the fourth message, the second access network device does not respond with a fourth response message for the fourth message. This implementation reduces network signaling overheads.

Optionally, after the first access network device sends the fourth message, the first access network device directly switches off the one or more cells. Alternatively, after waiting preset time, the first access network device switches off the one or more cells. This is not limited in at least one embodiment.

In at least one embodiment, step 412 and step 413 are not performed. To be specific, the first access network device does not send the fourth message to the second access network device, and the second access network device directly sends a twelfth message to the first access network device. The twelfth message is usable to indicate the first access network device to switch off the one or more cells. After receiving the twelfth message, the first access network device immediately switches off the one or more cells. This implementation reduces network signaling overheads, and also helps the second access network device better manage the first access network device.

Optionally, the twelfth message and the ninth message are a same message. For example, the twelfth message and the ninth message are represented by using a twelfth message. The twelfth message is usable to indicate to release context information of the one or more terminal devices and is usable to indicate to switch off the one or more cells. After the first access network device receives the twelfth message sent by the second access network device, the first access network device releases the context information of the one or more terminal devices, and switches off the one or more cells. This implementation reduces network signaling overheads.

414: The first access network device switches off one or more cells.

A specific implementation of step 414 is the same as the specific implementation of step 305. Details are not described again in at least one embodiment.

In at least one embodiment, after the handover of the one or more terminal devices is completed, the second access network device sends a thirteenth message to the one or more terminal devices. After receiving the thirteenth message, the terminal device sends a thirteenth response message to the second access network device. The thirteenth message is usable to indicate the terminal device to measure a signal of a neighboring cell, the thirteenth message includes measurement control information of the neighboring cell, and the thirteenth response message is usable to indicate that the thirteenth message has been received. Optionally, the thirteenth message is an RRC reconfiguration (RRC Reconfiguration) message, and the thirteenth response message is an RRC reconfiguration complete (RRC Reconfiguration Complete) message.

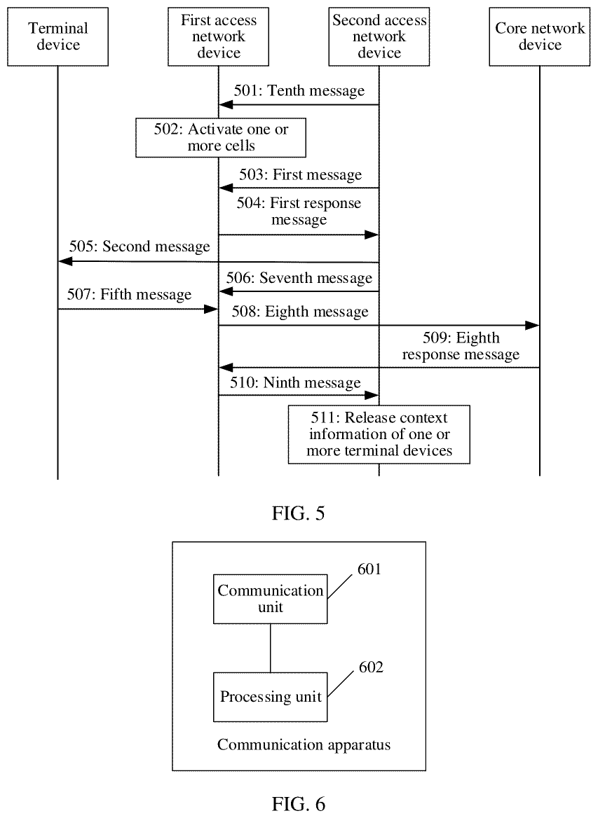

In response to an access network device being connected to an excessively large quantity of terminal devices and not being able to meet service usage of a large quantity of terminal devices, to reduce load of the access network device, at least one embodiment provides a network handover method. FIG. 5 is a schematic interaction diagram of another network handover method according to at least one embodiment. As shown in FIG. 5, the network handover method includes step 501 to step 511. For brief representation, only one terminal device is shown in FIG. 5. There are one or more terminal devices. This is not limited in at least one embodiment.

501: A second access network device sends a tenth message to a first access network device. Correspondingly, the first access network device receives the tenth message sent by the second access network device.

In at least one embodiment, the tenth message is usable to indicate to activate one or more cells served by the first access network device, and the tenth message is an activation signal. The tenth message includes the following one or more types of identifiers: an identifier of the one or more cells, an identifier of one or more RATs, an identifier of one or more sectors, and an identifier of one or more TRPs.

In at least one embodiment, in response to load of a network bearer of the second access network device being large or the second access network device not being able to meet a quality of service QoS of one or more terminal devices because the second access network device is connected to an excessively large quantity of terminal devices, the second access network device sends the tenth message. The tenth message is usable to indicate to activate the one or more cells served by the first access network device. The one or more cells served by the first access network device are activated by using the tenth message. One or more terminal devices under the second access network device are handed over to the cells served by the first access network device. This reduces load of the second access network device.

502: The first access network device activates one or more cells.

In at least one embodiment, the first access network device is in a sleep state, but still periodically detects whether the second access network device sends information to the first access network device, so as to better cooperate in management of the second access network device. After the first access network device receives the tenth message sent by the second access network device, the first access network device activates the one or more cells. There are two specific implementations in which the first access network device activates the one or more cells. In one implementation, the first access network device activates all cells, that is, the first access network device is activated. In the other implementation, the first access network device activates some cells.

A specific implementation of activating the first access network device includes any one of the following manners: starting a PA of the first access network device: starting a PA and a radio frequency component of the first access network device, where the radio frequency component includes an intermediate frequency component, a small signal processing component, and the like: or starting a PA, a radio frequency component, and a main device of the first access network device, where the main device includes devices such as a baseband board and a main control board.

503: The second access network device sends a first message to the first access network device. Correspondingly, the first access network device receives the first message sent by the second access network device.

In at least one embodiment, the first message is usable to request to hand over a group of terminal devices under the second access network device to the first access network device. The group of terminal devices includes one or more terminal devices. The one or more terminal devices are connected to the second access network device and camp on one or more cells served by the second access network device. The first message is a handover request message. The first message carries information about the one or more terminal devices, specifically including: a C-RNTI that corresponds to the terminal devices and that is of the second access network device and/or an AS configuration of the terminal devices. The AS configuration includes one or more of the following information: antenna information, a downlink carrier frequency, information about a correspondence between QoS and a DRB, capability information of the terminal devices, and PDU session related information.

In at least one embodiment, before the second access network device sends the first message to the first access network device, the method further includes: The first access network device sends an eleventh message to the second access network device. The eleventh message is usable to request to establish a connection to the second access network device. The second access network device sends an eleventh response message to the first access network device for the eleventh message. The eleventh response message is usable to indicate that the first access network device is allowed to establish the connection to the second access network device. For specific descriptions of the eleventh message and the eleventh response message, refer to the descriptions in step 301. Details are not described again in at least one embodiment.

504: The first access network device sends a first response message to the second access network device. Correspondingly, the second access network device receives the first response message sent by the first access network device.

In at least one embodiment, the first response message is usable to indicate that the one or more terminal devices are allowed to be handed over to the first access network device. The first response message is a handover request response (e.g. Handover Request Acknowledge) message. The first response message includes RRC configuration information corresponding to the one or more terminal devices. The RRC configuration information includes one or more of the following: a C-RNTI that corresponds to the terminal devices and that is of the second access network device, a target cell identifier, a security identifier, or RACH information corresponding to the terminal devices. The target cell identifier is an identifier of a cell on which the terminal device is to camp under the first access network device.

505: The second access network device sends a second message to a terminal device. Correspondingly, the terminal device receives the second message sent by the second access network device.

In at least one embodiment, the terminal device described herein is one terminal device or is a plurality of terminal devices. A quantity of terminal devices herein is not limited in at least one embodiment. The second message is usable to indicate the terminal device to be handed over to the first access network device. The second message is an RRC reconfiguration (e.g. RRC Reconfiguration) message.

In at least one embodiment, a specific implementation of step 505 is: The second access network device multicasts the second message to the one or more terminal devices. The second message includes dedicated configuration information and common configuration information. The common configuration information includes one or more of the following information: cell-specific PDCCH configuration information, cell-specific PDSCH configuration information, cell-specific PUCCH configuration information, cell-specific PUSCH configuration information, a physical cell identifier of the second access network device, and another cell-specific configuration shown in ServingCellConfigCommon in the protocol TS 38.331. This is not limited in at least one embodiment. The dedicated configuration information includes one or more of the following information: RACH configuration information of the one or more terminal devices, CSI or measurement configuration information of the one or more terminal devices, a new identifier of the one or more terminal devices, a UE-specific PDCCH configuration of the one or more terminal devices, a UE-specific PDSCH configuration of the one or more terminal devices, another UE-specific configuration shown in spCellConfigDedicated in the protocol TS 38.331, and the like. This is not limited in at least one embodiment. Based on this implementation, in a multicast manner, one message carries information about a plurality of terminal devices. This avoids repeated sending of a common configuration, and helps reduce signaling overheads.

Optionally, before the second access network device multicasts the second message to the one or more terminal devices, the second access network device sends reconfiguration related information to the one or more terminal devices in advance. The reconfiguration related information is usable to help the terminal devices parse content in the second message. The reconfiguration related information includes any one or more of the following information: an encryption algorithm for the second message, a key corresponding to the second message, and an RNTI. The method improves security of the second message.

In at least one embodiment, a specific implementation of step 505 is: The second access network device multicasts the second message to the one or more terminal devices. The second message carries common configuration information. The common configuration information includes one or more of the following information: cell-specific PDCCH configuration information, cell-specific PDSCH configuration information, cell-specific PUCCH configuration information, cell-specific PUSCH configuration information, a physical cell identifier of the second access network device, and another cell-specific configuration shown in ServingCellConfigCommon in the protocol TS 38.331. This is not limited in at least one embodiment. The method further includes: The second access network device unicasts corresponding dedicated configuration information to the one or more terminal devices. The dedicated configuration information includes one or more of the following information: RACH configuration information of the one or more terminal devices, CSI or measurement configuration information of the one or more terminal devices, a new identifier of the one or more terminal devices, a UE-specific PDCCH configuration of the one or more terminal devices, a UE-specific PDSCH configuration of the one or more terminal devices, another UE-specific configuration shown in spCellConfigDedicated in the protocol TS 38.331, and the like. This is not limited in at least one embodiment. Based on this implementation, the second access network device sends the common configuration information in a multicast manner and sends the dedicated configuration information in a unicast manner. The dedicated configuration information received by the terminal devices includes only the configuration information usable by the terminal devices, and has high security.

506: The second access network device sends a seventh message to the first access network device. Correspondingly, the first access network device receives the seventh message sent by the second access network device.

In at least one embodiment, the seventh message includes a C-RNTI that corresponds to the terminal device and that is of the second access network device, a C-RNTI that corresponds to the terminal device and that is of the first access network device, a PDCP sequence number of a DRB, and an HFN. After receiving the second message sent by the second access network device, the terminal device starts to perform network handover. However, before the terminal device completes handover, the terminal device still transmits a part of service data to the second access network device. However, because the terminal device is handed over to the first access network device, the second access network device forwards this part of data to the first access network device for processing. The seventh message is usable to determine a data packet marker during data forwarding, to ensure sequential transmission of data and prevent a data loss.

In at least one embodiment, transmission between the first access network device and the second access network device is performed in an air interface manner. In a data forwarding phase, a corresponding DRB is to be established to bear corresponding user data. Specifically, the following two types of DRBs are established.

In an implementation, the second access network device sends a first configuration message to the first access network device. The first configuration message includes configuration information of a DRB. The second access network device forwards data of a first terminal device to the first access network device through one or N DRBs corresponding to the first terminal device. The first terminal device is any one of the one or more terminal devices, and N is a positive integer and is greater than 1. In this implementation, one terminal device corresponds to one or N DRBs. The second access network device determines, through the DRB, a terminal device from which the data comes. Based on this implementation, different services are provided for different terminal devices. For example, a terminal device with a higher priority corresponds to a larger quantity of DRBs.

In another implementation, the second access network device sends a second configuration message to the first access network device. The second configuration message includes configuration information of one or more data radio bearers (DRBs). The second access network device forwards data of a first terminal device to the first access network device through the one or more DRBs. A packet header of the data includes an identifier of the first terminal device and a length of the data, and the first terminal device is any one of the one or more terminal devices. In this implementation, a DRB corresponding to each terminal device is the same. The second access network device determines, based on a packet header of a data packet, a terminal device from which the data comes. Based on this implementation, establishing the DRB is more convenient.

507: The terminal device sends a fifth message to the first access network device. Correspondingly, the first access network device receives the fifth message sent by the terminal device.

In at least one embodiment, the fifth message is usable to indicate that the terminal device requests to be handed over to the first access network device. Related descriptions of the fifth message are the same as those in step 304. Details are not described again in at least one embodiment.

508: The first access network device sends an eighth message to a core network device. Correspondingly, the core network device receives the eighth message sent by the first access network device.

In at least one embodiment, the eighth message is usable to indicate that the one or more terminal devices are handed over to the first access network device. The eighth message is a path switch request (e.g. Path switch request) message, and the message includes an identifier of the one or more terminal devices. Optionally, the core network device is an AMF device. In addition, the core network device is alternatively a core network device in a communication system evolved after 5G or 6G. This is not limited in at least one embodiment.

509: The core network device sends an eighth response message to the first access network device. Correspondingly, the first access network device receives the eighth response message sent by the core network device.

The eighth response message is the same as the eighth response message described in step 409. Details are not described again in at least one embodiment.

510: The first access network device sends a ninth message to the second access network device. Correspondingly, the second access network device receives the ninth message sent by the first access network device.

In at least one embodiment, the ninth message is usable to indicate the second access network device to release context information of the one or more terminal devices. The ninth message includes identification information of the one or more terminal devices.

511: The second access network device releases the context information of the one or more terminal devices.

In at least one embodiment, after the second access network device receives the ninth message from the first access network device, the second access network device determines that the one or more terminal devices have been handed over to the first access network device, and therefore releases the context information of the one or more terminal devices. Based on the method, the one or more terminal devices under the second access network device is handed over to the first access network device. This helps reduce load of the second access network device.

To implement functions in the foregoing methods provided in at least one embodiment, the first access network device, the second access network device, and the terminal device each includes a hardware structure and/or a software module, and implement the foregoing functions in a form of the hardware structure, the software module, or a combination of the hardware structure and the software module. Whether a function in the foregoing functions is performed by using the hardware structure, the software module, or the combination of the hardware structure and the software module depends on particular embodiments and design constraints of the technical solutions.

FIG. 6 is a schematic diagram of a structure of a communication apparatus according to at least one embodiment. The communication apparatus is a first access network device, a second access network device, or a terminal device, or is an apparatus in the first access network device, the second access network device, or the terminal device, or is an apparatus that is usable together with the first access network device, the second access network device, or the terminal device. In at least one embodiment, the communication apparatus includes modules or units that are in one-to-one correspondence with the methods/operations/steps/actions performed by the first access network device, the second access network device, or the terminal device in the foregoing method embodiments. The unit is implemented by a hardware circuit, software, or a combination of the hardware circuit and the software.

In at least one embodiment, the apparatus is the first access network device, or is the apparatus in the first access network device, or the apparatus that is usable together with the first access network device. The communication apparatus is alternatively a chip system.

The communication apparatus shown in FIG. 6 is the first access network device, or is the apparatus in the first access network device, or the apparatus that is usable together with the first access network device. The communication apparatus is alternatively a chip system. The apparatus is configured to perform some or all functions of the first access network device in the method embodiments described in FIG. 3 and FIG. 4. The communication apparatus shown in FIG. 6 includes a communication unit 601 and a processing unit 602. The processing unit 602 is configured to perform data processing. A receiving unit and a sending unit are integrated into the communication unit 601. The communication unit 601 is also referred to as a transceiver unit. Alternatively, the communication unit 601 is split into a receiving unit and a sending unit. The processing unit 602 below is similar to the communication unit 601 in message processing. Details are not described again below.

The communication unit 601 is configured to send a first message to a second access network device. The first message is usable to request to hand over a group of terminal devices under the first access network device to the second access network device, and the group of terminal devices includes one or more terminal devices. The communication unit 601 is further configured to send a second message to the one or more terminal devices in response to a first response message from the second access network device for the first message being received. The first response message is usable to indicate that the one or more terminal devices are allowed to be handed over to the second access network device, and the second message is usable to indicate the terminal devices to be handed over to the second access network device. The processing unit 602 is configured to switch off one or more cells after the one or more terminal devices are handed over to the second access network device.

In at least one embodiment, in response to sending the second message to the one or more terminal devices, the communication unit 601 is specifically configured to: multicast the second message to the one or more terminal devices. The second message includes dedicated configuration information and common configuration information, the dedicated configuration information includes one or more of the following: random access channel (RACH) configuration information of the one or more terminal devices, or channel state information (CSI) or measurement configuration information of the one or more terminal devices, and the common configuration information includes one or more of the following: physical downlink control channel (PDCCH) configuration information, physical downlink shared channel (PDSCH) configuration information, physical uplink control channel (PUCCH) configuration information, or physical uplink shared channel (PUSCH) configuration information.

In at least one embodiment, in response to sending the second message to the one or more terminal devices, the communication unit 601 is specifically configured to: multicast the second message to the one or more terminal devices. The second message carries common configuration information, and the common configuration information includes one or more of the following: physical downlink control channel (PDCCH) configuration information, physical downlink shared channel (PDSCH) configuration information, physical uplink control channel (PUCCH) configuration information, or physical uplink shared channel (PUSCH) configuration information. The communication unit 601 is further configured to: unicast corresponding dedicated configuration information to the one or more terminal devices. The dedicated configuration information includes one or more of the following: random access channel (RACH) configuration information of the one or more terminal devices, or channel state information (CSI) or measurement configuration information of the one or more terminal devices.

In at least one embodiment, before the communication unit 601 is configured to send the first message to the second access network device, the communication unit 601 is further configured to send a third message to the second access network device. The third message is usable to request to switch off the one or more cells. The communication unit 601 is further configured to receive a third response message from the second access network device for the third message. The third response message is usable to indicate that the one or more cells are allowed to be switched off.

In at least one embodiment, the first message further is usable to indicate to request to switch off the one or more cells, and the first response message is usable to indicate that the one or more cells are allowed to be switched off.

In at least one embodiment, before the processing unit 602 is configured to switch off the cells, the communication unit 601 is further configured to send a fourth message to the second access network device. The fourth message is usable to notify the second access network device that the communication apparatus is to switch off the one or more cells.

In at least one embodiment, the communication unit 601 is further configured to receive a fourth response message from the second access network device for the fourth message. The fourth response message is usable to indicate that the one or more cells are allowed to be switched off.

In at least one embodiment, before the processing unit 602 is configured to switch off the cells, the communication unit 601 is further configured to send a fourth message to the second access network device. The fourth message is usable to indicate that the one or more cells are to be switched off.

In at least one embodiment, before the processing unit 602 is configured to switch off the cells, the communication unit 601 is further configured to receive a twelfth message from the second access network device. The twelfth message is usable to indicate to switch off the one or more cells.

In at least one embodiment, the communication unit 601 is further configured to receive a first configuration message from the second access network device. The first configuration message includes configuration information of a data radio bearer (DRB). The communication unit 601 is further configured to forward data of a first terminal device to the second access network device through one or N DRBs corresponding to the first terminal device. The first terminal device is any one of the one or more terminal devices, and N is a positive integer and is greater than 1.

In at least one embodiment, the communication unit 601 is further configured to receive a second configuration message from the second access network device. The second configuration message includes configuration information of one or more data radio bearers (DRBs). The communication unit 601 is further configured to forward data of a first terminal device to the second access network device through the one or more DRBs. A packet header of the data includes an identifier of the first terminal device and a length of the data, and the first terminal device is any one of the one or more terminal devices.

In at least one embodiment, after the communication unit 601 is further configured to send the first message to the second access network device, the processing unit 602 is further configured to start a timer. Timing duration of the timer is determined based on a type of the second access network device. The communication unit 601 is further configured to send a sixth message to the second access network device in response to the timer expiring and the communication unit not receiving the first response message. The sixth message is usable to indicate to cancel the handover of the one or more terminal devices.

In at least one embodiment, after the communication unit 601 is configured to send the second message to the one or more terminal devices, the communication unit 601 is further configured to send a seventh message to the second access network device. The seventh message includes one or more of the following: a cell-radio network temporary identifier C-RNTI that corresponds to the terminal devices and that is of the first access network device, a C-RNTI that corresponds to the terminal devices and that is of the second access network device, a packet data convergence protocol (PDCP) sequence number of the DRB, and a hyper frame number (HFN).

In at least one embodiment, before the processing unit 602 is configured to switch off the one or more cells, the communication unit 601 is further configured to receive a ninth message from the second access network device. The processing unit 602 is further configured to release context information of the one or more terminal devices based on the ninth message.

In at least one embodiment of the communication apparatus, refer to the related descriptions of the functions of the first access network device in the method embodiments corresponding to FIG. 3 and FIG. 4. Details are not described herein again.

The communication apparatus shown in FIG. 6 is alternatively configured to perform some or all functions of the first access network device in the method embodiment described in FIG. 5.

The communication unit 601 is configured to receive a first message sent by a second access network device. The first message is usable to request to hand over a group of terminal devices under the second access network device to the first access network device, and the group of terminal devices includes one or more terminal devices. The communication unit 601 is further configured to send a first response message to the second access network device for the first message. The first response message is usable to indicate that the one or more terminal devices are allowed to be handed over to the first access network device. The communication unit 601 is further configured to receive a fifth message sent by the one or more terminal devices. The fifth message is usable to indicate that the terminal devices request to be handed over to the first access network device.

In at least one embodiment, before the communication unit 601 is configured to receive the first message sent by the second access network device, the communication unit 601 is further configured to receive a tenth message from the second access network device. The tenth message is usable to indicate the first access network device to switch on one or more cells.

In at least one embodiment, before the communication unit 601 is configured to receive the first message sent by the second access network device, the communication unit 601 is further configured to receive an eleventh message from the first access network device. The eleventh message is usable to indicate the first access network device to request to establish a connection to the second access network device. The communication unit 601 is further configured to send an eleventh response message to the second access network device for the eleventh message. The eleventh response message is usable to indicate that the connection to the second access network device is allowed to be established.

In at least one embodiment, the communication unit 601 is further configured to receive a first configuration message sent by the second access network device. The first configuration message includes configuration information of a data radio bearer (DRB). The communication unit 601 is further configured to receive, through the DRB, data that is of a first terminal device corresponding to the DRB and that is sent by the second access network device. The first terminal device is any one of the one or more terminal devices.

In at least one embodiment, the communication unit 601 is further configured to receive a second configuration message sent by the second access network device. The second configuration message includes configuration information of one or more data radio bearers (DRBs). The communication unit 601 is further configured to receive, through the one or more DRBs, data forwarded the second access network device. A packet header of the data includes an identifier of a first terminal device and a length of the data, the identifier is usable to indicate that the data is from the first terminal device, and the first terminal device is any one of the one or more terminal devices.

In at least one embodiment, the communication unit 601 is further configured to receive a seventh message from the second access network device. The seventh message includes a C-RNTI that corresponds to the terminal devices and that is of the first access network device, a C-RNTI that corresponds to the terminal devices and that is of the second access network device, a packet data convergence protocol (PDCP) sequence number of the DRB, and a hyper frame number (HFN).

In at least one embodiment, after the communication unit 601 is configured to receive the fifth message sent by the one or more terminal devices, the communication unit 601 is further configured to send an eighth message to a core network device. The eighth message is usable to indicate that the one or more terminal devices are handed over to the first access network device. The communication unit 601 is further configured to receive an eighth response message sent by the core network device for the eighth message.

In at least one embodiment, after the communication unit 601 is configured to receive the fifth message sent by the one or more terminal devices, the communication unit 601 is further configured to send a ninth message to the second access network device. The ninth message is usable to indicate the second access network device to release context information of the one or more terminal devices.

In at least one embodiment of the communication apparatus, refer to the related descriptions of the functions of the first access network device in the method embodiment corresponding to FIG. 5. Details are not described herein again.

In at least one embodiment, the communication apparatus shown in FIG. 6 is the second access network device, or is the apparatus in the second access network device, or the apparatus that is usable together with the second access network device. The communication apparatus is alternatively a chip system. The apparatus is configured to perform some or all functions of the second access network device in the method embodiments described in FIG. 3 and FIG. 4. The communication apparatus shown in FIG. 6 includes a communication unit 601 and a processing unit 602.

The communication unit 601 is configured to receive a first message sent by a first access network device. The first message is usable to request to hand over a group of terminal devices under the first access network device to the second access network device, and the group of terminal devices includes one or more terminal devices. The communication unit 601 is further configured to send a first response message to the first access network device for the first message. The first response message is usable to indicate that the one or more terminal devices are allowed to be handed over to the second access network device. The communication unit 601 is further configured to receive a fifth message sent by the one or more terminal devices. The fifth message is usable to indicate that the terminal devices request to be handed over to the second access network device.

In at least one embodiment, before the communication unit 601 is configured to receive the first message sent by the first access network device, the communication unit 601 is further configured to receive a third message from the first access network device. The third message is usable to request to switch off one or more cells. The communication unit 601 is further configured to send a third response message to the first access network device for the third message. The third response message is usable to indicate that the one or more cells are allowed to be switched off.

In at least one embodiment, the first message further is usable to indicate to request to switch off the one or more cells, and the first response message is usable to indicate that the one or more cells are allowed to be switched off.

In at least one embodiment, after the communication unit 601 is configured to receive a fourth message from the first access network device, the communication unit 601 is further configured to send a fourth response message to the first access network device for the fourth message. The fourth message is usable to indicate that the first access network device is to switch off the one or more cells, and the fourth response message is usable to indicate that the second access network device allows to switch off the one or more cells.

In at least one embodiment, the communication unit 601 is further configured to send a twelfth message to the first access network device. The twelfth message is usable to indicate the first access network device to switch off the one or more cells.

In at least one embodiment, the communication unit 601 is further configured to send a first configuration message to the first access network device. The first configuration message includes configuration information of a data radio bearer (DRB). The communication unit 601 is further configured to receive, through the DRB, data that is of a first terminal device corresponding to the DRB and that is sent by the first access network device. The first terminal device is any one of the one or more terminal devices.

In at least one embodiment, the communication unit 601 is further configured to send a second configuration message to the first access network device. The second configuration message includes configuration information of one or more data radio bearers (DRBs). The communication unit 601 is further configured to receive, through the one or more DRBs, data forwarded the first access network device. A packet header of the data includes an identifier of a first terminal device and a length of the data, the identifier is usable to indicate that the data is from the first terminal device, and the first terminal device is any one of the one or more terminal devices.

In at least one embodiment, in response to the communication unit 601 not sending the first response message to the first access network device for the first message, the communication unit 601 is further configured to receive a sixth message sent by the first access network device. The sixth message is usable to indicate to cancel the handover of the one or more terminal devices.

In at least one embodiment, after the communication unit 601 is configured to send the first response message to the first access network device for the first message, the communication unit 601 is further configured to receive a seventh message from the first access network device. The seventh message includes a C-RNTI that corresponds to the terminal devices and that is of the first access network device, a C-RNTI that corresponds to the terminal devices and that is of the second access network device, a packet data convergence protocol (PDCP) sequence number of the DRB, and a hyper frame number (HFN).

In at least one embodiment, after the communication unit 601 is configured to receive the fifth message sent by the one or more terminal devices, the communication unit 601 is further configured to send an eighth message to a core network device. The eighth message is usable to indicate that the one or more terminal devices are handed over to the second access network device. The communication unit 601 is further configured to receive an eighth response message sent by the core network device for the eighth message.

In at least one embodiment, after the communication unit 601 is configured to receive the fifth message sent by the one or more terminal devices, the communication unit 601 is further configured to send a ninth message to the first access network device. The ninth message is usable to indicate the first access network device to release context information of the one or more terminal devices.

In at least one embodiment of the communication apparatus, refer to the related descriptions of the functions of the second access network device in the method embodiments corresponding to FIG. 3 and FIG. 4. Details are not described herein again.

The communication apparatus shown in FIG. 6 is alternatively configured to perform some or all functions of the second access network device in the method embodiment described in FIG. 5.

The communication unit 601 is configured to send a first message to a first access network device. The first message is usable to request to hand over a group of terminal devices under the second access network device to the first access network device, and the group of terminal devices includes one or more terminal devices. The communication unit 601 is further configured to send a second message to the one or more terminal devices in response to a first response message from the first access network device for the first message being received. The first response message is usable to indicate that the one or more terminal devices are allowed to be handed over to the first access network device, and the second message is usable to indicate the terminal devices to be handed over to the first access network device.

In at least one embodiment, before the communication unit 601 is configured to send the first message to the first access network device, the communication unit 601 is further configured to send a tenth message to the first access network device. The tenth message is usable to indicate the first access network device to switch on one or more cells.

In at least one embodiment, the second message includes dedicated configuration information and common configuration information, the dedicated configuration information includes one or more of the following: random access channel (RACH) configuration information of the one or more terminal devices, or channel state information (CSI) or measurement configuration information of the one or more terminal devices, and the common configuration information includes one or more of the following: physical downlink control channel (PDCCH) configuration information, physical downlink shared channel (PDSCH) configuration information, physical uplink control channel (PUCCH) configuration information, or physical uplink shared channel (PUSCH) configuration information.

In at least one embodiment, in response to the communication unit 601 being configured to send the second message to the one or more terminal devices, the communication unit 601 is specifically configured to: multicast the second message to the one or more terminal devices. The second message carries common configuration information, and the common configuration information includes one or more of the following: physical downlink control channel (PDCCH) configuration information, physical downlink shared channel (PDSCH) configuration information, physical uplink control channel (PUCCH) configuration information, or physical uplink shared channel (PUSCH) configuration information. The communication unit 601 is further configured to unicast corresponding dedicated configuration information to the one or more terminal devices. The dedicated configuration information includes one or more of the following: random access channel (RACH) configuration information corresponding to the terminal devices, or channel state information (CSI) or measurement configuration information of the terminal devices.

In at least one embodiment, after the communication unit 601 is configured to send the first message to the first access network device, the communication unit 601 is further configured to receive an eleventh message from the first access network device. The eleventh message is usable to request to establish a connection to the second access network device. The communication unit 601 is configured to send an eleventh response message to the first access network device for the eleventh message. The eleventh response message is usable to indicate that the first access network device is allowed to establish the connection to the second access network device.

In at least one embodiment, the communication unit 601 is further configured to send a first configuration message to the first access network device. The first configuration message includes configuration information of a data radio bearer (DRB). The communication unit 601 is further configured to forward data of a first terminal device to the first access network device through one or N DRBs corresponding to the first terminal device. The first terminal device is any one of the one or more terminal devices, and N is a positive integer and is greater than 1.

In at least one embodiment, the communication unit 601 is further configured to send a second configuration message to the first access network device. The second configuration message includes configuration information of one or more data radio bearers (DRBs). The communication unit 601 is further configured to forward data of a first terminal device to the first access network device through the one or more DRBs. A packet header of the data includes an identifier of the first terminal device and a length of the data, and the first terminal device is any one of the one or more terminal devices.

In at least one embodiment, after the communication unit 601 is configured to send the second message to the one or more terminal devices, the communication unit 601 is further configured to send a seventh message to the first access network device. The seventh message includes a C-RNTI that corresponds to the terminal devices and that is of the first access network device, a C-RNTI that corresponds to the terminal devices and that is of the second access network device, a packet data convergence protocol (PDCP) sequence number of the DRB, and a hyper frame number (HFN).

In at least one embodiment, the communication unit 601 is further configured to receive a ninth message from the first access network device. The processing unit 602 is further configured to release context information of the one or more terminal devices based on the ninth message.

In at least one embodiment of the communication apparatus, refer to the related descriptions of the functions of the second access network device in the method embodiment corresponding to FIG. 5. Details are not described herein again.

In at least one embodiment, the communication apparatus shown in FIG. 6 is the terminal device, or is the apparatus in the terminal device, or the apparatus that is usable together with the terminal device. The communication apparatus is alternatively a chip system. The apparatus is configured to perform some or all functions of the terminal device in the method embodiments described in FIG. 3 and FIG. 4. The communication apparatus shown in FIG. 6 includes a communication unit 601 and a processing unit 602.

The communication unit 601 is configured to receive a second message sent by a first access network device. The second message is usable to indicate the terminal device to be handed over to a second access network device. The communication unit 601 is further configured to send a fifth message to the second access network device. The fifth message is usable to request to be handed over to the second access network device.

In at least one embodiment, the second message includes dedicated configuration information and common configuration information, the dedicated configuration information includes one or more of the following: random access channel (RACH) configuration information of one or more terminal devices, or channel state information (CSI) or measurement configuration information of the one or more terminal devices, and the common configuration information includes one or more of the following: physical downlink control channel (PDCCH) configuration information, physical downlink shared channel (PDSCH) configuration information, physical uplink control channel (PUCCH) configuration information, or physical uplink shared channel (PUSCH) configuration information.

In at least one embodiment, the second message carries common configuration information, and the common configuration information includes one or more of the following: physical downlink control channel (PDCCH) configuration information, physical downlink shared channel (PDSCH) configuration information, physical uplink control channel (PUCCH) configuration information, or physical uplink shared channel (PUSCH) configuration information. The communication unit 601 is further configured to receive dedicated configuration information sent by the first access network device. The dedicated configuration information includes one or more of the following: random access channel (RACH) configuration information corresponding to the terminal device, or channel state information (CSI) or measurement configuration information of the terminal device.

In at least one embodiment of the communication apparatus, refer to the related descriptions of the functions of the terminal device in the method embodiments corresponding to FIG. 3 and FIG. 4. Details are not described herein again.

The communication apparatus shown in FIG. 6 is alternatively configured to perform some or all functions of the terminal device in the method embodiment described in FIG. 5.

The communication unit 601 is configured to receive a second message sent by a second access network device. The second message is usable to indicate the terminal device to be handed over to a first access network device. The communication unit 601 is further configured to send a fifth message to the first access network device. The fifth message is usable to request to be handed over to the first access network device.

In at least one embodiment, the second message includes dedicated configuration information and common configuration information, the dedicated configuration information includes one or more of the following: random access channel (RACH) configuration information of one or more terminal devices, or channel state information (CSI) or measurement configuration information of the one or more terminal devices, and the common configuration information includes one or more of the following: physical downlink control channel (PDCCH) configuration information, physical downlink shared channel (PDSCH) configuration information, physical uplink control channel (PUCCH) configuration information, or physical uplink shared channel (PUSCH) configuration information.

In at least one embodiment, the second message carries common configuration information, and the common configuration information includes one or more of the following: physical downlink control channel (PDCCH) configuration information, physical downlink shared channel (PDSCH) configuration information, physical uplink control channel (PUCCH) configuration information, or physical uplink shared channel (PUSCH) configuration information. The communication unit 601 is further configured to receive dedicated configuration information sent by the second access network device. The dedicated configuration information includes one or more of the following: random access channel (RACH) configuration information corresponding to the terminal device, or channel state information (CSI) or measurement configuration information of the terminal device.

In at least one embodiment of the communication apparatus, refer to the related descriptions of the functions of the terminal device in the method embodiment corresponding to FIG. 5. Details are not described herein again.

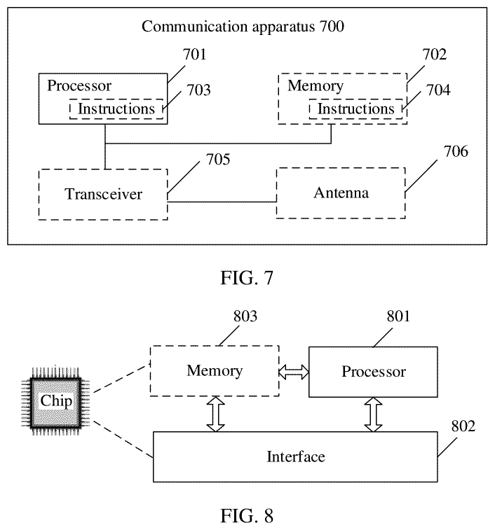

FIG. 7 is a schematic diagram of a structure of a communication apparatus. The communication apparatus 700 is the terminal device in the foregoing method embodiments, or is a chip, a chip system, a processor, or the like that supports the terminal device in implementing the foregoing methods. The communication apparatus is configured to implement the methods described in the foregoing method embodiments. For details, refer to the descriptions in the foregoing method embodiments.

Alternatively, the communication apparatus 700 is the first access network device in the foregoing method embodiments, or is a chip, a chip system, a processor, or the like that supports the first access network device in implementing the foregoing methods. The communication apparatus is configured to implement the methods described in the foregoing method embodiments. For details, refer to the descriptions in the foregoing method embodiments.

Alternatively, the communication apparatus 700 is the second access network device in the foregoing method embodiments, or is a chip, a chip system, a processor, or the like that supports the second access network device in implementing the foregoing methods. The communication apparatus is configured to implement the methods described in the foregoing method embodiments. For details, refer to the descriptions in the foregoing method embodiments.

The communication apparatus 700 includes one or more processors 701. The processor 701 is a general purpose processor or a special purpose processor or the like. For example, the processor is a baseband processor or a central processing unit. The baseband processor is configured to process a communication protocol and communication data. The central processing unit is configured to control a communication apparatus (for example, a base station, a baseband chip, a terminal, a terminal chip, a DU, or a CU), execute a software program, and process data of the software program.

Optionally, the communication apparatus 700 includes one or more memories 702. The memory stores instructions 704, and the instructions are run on the processor 701, so that the communication apparatus 700 performs the methods described in the foregoing method embodiments. Optionally, the memory 702 also stores data. The processor 701 and the memory 702 are separately disposed, or are integrated together.

Optionally, the communication apparatus 700 further includes a transceiver 705 and an antenna 706. The transceiver 705 is referred to as a transceiver unit, a transceiver, a transceiver circuit, or the like, and is configured to implement receiving and sending functions. The transceiver 705 includes a receiver and a transmitter. The receiver is referred to as a receiving machine, a receiving circuit, or the like, and is configured to implement a receiving function. The transmitter is referred to as a sending machine, a sending circuit, or the like, and is configured to implement a sending function.

In response to the communication apparatus 700 being the terminal device, the processor 701 is configured to perform a data processing operation performed by the terminal device in the foregoing method embodiments. The transceiver 705 is configured to perform a data sending/receiving operation performed by the terminal device in the foregoing method embodiments.

Alternatively, in response to the communication apparatus 700 being the first access network device, the processor 701 is configured to perform a data processing operation performed by the first access network device in the foregoing method embodiments. The transceiver 705 is configured to perform a data sending/receiving operation performed by the first access network device in the foregoing method embodiments.

Alternatively, in response to the communication apparatus 700 being the second access network device, the processor 701 is configured to perform a data processing operation performed by the second access network device in the foregoing method embodiments. The transceiver 705 is configured to perform a data sending/receiving operation performed by the second access network device in the foregoing method embodiments.

In at least one embodiment, the processor 701 includes a transceiver configured to implement receiving and sending functions. For example, the transceiver is a transceiver circuit, an interface, or an interface circuit. The transceiver circuit, the interface, or the interface circuit configured to implement the receiving and sending functions is separated, or is integrated together. The transceiver circuit, the interface, or the interface circuit is configured to read and write code/data. Alternatively, the transceiver circuit, the interface, or the interface circuit is configured to transmit or transfer a signal.

In at least one embodiment, optionally, the processor 701 stores instructions 703. In response to the instructions 703 being run on the processor 701, the communication apparatus 700 is enabled to perform the methods described in the foregoing method embodiments. The instructions 703 are fixed in the processor 701. In this case, the processor 701 is implemented by hardware.

In at least one embodiment, the communication apparatus 700 includes a circuit, and the circuit implements the sending, receiving, or communication function in the foregoing method embodiments. The processor and the transceiver described in at least one embodiment is implemented on an integrated circuit (IC), an analog IC, a radio frequency integrated circuit (RFIC), a hybrid signal IC, an application-specific integrated circuit (ASIC), a printed circuit board (PCB), an electronic device, or the like.

The communication apparatus described in the foregoing embodiments is the terminal device, the first access network device, or the second access network device. However, a scope of the communication apparatus described in at least one embodiment is not limited thereto, and a structure of the communication apparatus is not limited by the structure in FIG. 7. The communication apparatus is an independent device or is a part of a large device. For example, the communication apparatus is:
(1) an independent integrated circuit (IC), a chip, or a chip system or subsystem:
(2) a set that has one or more ICs, where optionally, the IC set alternatively includes a storage component configured to store data and instructions:
(3) an ASIC, for example, a modem (e.g. Mobile Station Modem (MSM)):
(4) a module that is embedded in another device:
(5) a receiver, a terminal, an intelligent terminal, a cellular phone, a wireless device, a handheld device, a mobile unit, a vehicle-mounted device, a network device, a cloud device, an artificial intelligence device, or the like: or
(6) another device.

For a case in which the communication apparatus is a chip or a chip system, refer to a schematic diagram of a structure of a chip shown in FIG. 8. The chip shown in FIG. 8 includes a processor 801 and an interface 802. Optionally, the chip further includes a memory 803. There are one or more processors 801, and there are a plurality of interfaces 802.

In a design, in response to the chip being configured to implement functions of the terminal device in at least one embodiment,
the interface 802 is configured to input or output a signal, and
the processor 801 is configured to perform a data processing operation performed by the terminal device in the foregoing method embodiments.

In another design, in response to the chip being configured to implement functions of the access network device in at least one embodiment,
the interface 802 is configured to input or output a signal, and
the processor 801 is configured to perform a data processing operation performed by the access network device in the foregoing method embodiments.

In some scenarios, some optional features in at least one embodiment are independently implemented without depending on another feature, for example, a solution on which the optional features are currently based, to resolve a corresponding technical problem and achieve corresponding effect, or is combined with other features based on usage in some scenarios. Correspondingly, the communication apparatus provided in at least one embodiment also correspondingly implements these features or functions. Details are not described herein.

The processor in at least one embodiment is an integrated circuit chip, and has a signal processing capability. In an implementation process, steps in the foregoing method embodiments are implemented by using a hardware integrated logical circuit in the processor, or by using instructions in a form of software. The processor is a general purpose processor, a digital signal processor (DSP), an ASIC, a field programmable gate array (FPGA) or another programmable logic device, a discrete gate or a transistor logic device, or a discrete hardware component.

The memory in at least one embodiment is a volatile memory or a nonvolatile memory, or includes a volatile memory and a nonvolatile memory. The nonvolatile memory is a read-only memory (ROM), a programmable read-only memory (PROM), an erasable programmable read-only memory (EPROM), an electrically erasable programmable read-only memory (EEPROM), or a flash memory. The volatile memory is a random access memory (RAM), usable as an external cache. Through example but not limitative description, many forms of RAMs is used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchronous link dynamic random access memory (SLDRAM), and a direct rambus dynamic random access memory (DR RAM). The memory of the systems and methods described in at least one embodiment includes but is not limited to these and any memory of another proper type.

At least one embodiment further provides a computer-readable medium, configured to store computer software instructions. In response to the instructions being executed by a communication apparatus, the function in any one of the foregoing method embodiments is implemented.

At least one embodiment further provides a computer program product, configured to store computer software instructions. In response to the instructions being executed by a communication apparatus, the function in any one of the foregoing method embodiments is implemented.

All or some of the foregoing embodiments are implemented by using software, hardware, firmware, or any combination thereof. In response to software being used to implement embodiments, embodiments are implemented completely or partially in a form of a computer program product. The computer program product includes one or more computer instructions. In response to the computer instructions being loaded and executed on the computer, the procedure or functions according to at least one embodiment are all or partially generated. The computer is a general purpose computer, a dedicated computer, a computer network, or other programmable apparatuses. The computer instructions are stored in a computer-readable storage medium or is transmitted from a computer-readable storage medium to another computer-readable storage medium. For example, the computer instructions are transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium is any usable medium accessible by a computer, or a data storage device, such as a server or a data center, integrating one or more usable media. The usable medium is a magnetic medium (for example, a floppy disk, a hard disk, or a magnetic tape), an optical medium (for example, a high-density digital video disc (DVD)), a semiconductor medium (for example, a solid state drive (SSD)), or the like.

In the foregoing embodiments, the descriptions of embodiments have respective focuses. For a part that is not described in detail in an embodiment, refer to related descriptions in other embodiments.

Finally, the foregoing embodiments are merely intended for describing the technical solutions described herein other than limiting at least one embodiment. Although embodiments are described in detail, persons of ordinary skill in the art understand that modifications to the technical solutions described in the foregoing embodiments are able to be made or equivalent replacements are able to be made to some or all technical features thereof, without departing from the scope of the technical solutions of embodiments described herein.

1. A method, wherein the method is applied to a first apparatus and the method comprises:
sending a first message to a second apparatus, wherein the first message is used usable to request to hand over a group of terminal apparatuses under the first apparatus to the second access network apparatus, and the group of terminal apparatuses includes one or more terminal apparatuses:
receiving a first response message from the second apparatus for the first message, wherein the first response message is usable to indicate that the one or more terminal apparatuses are allowed to be handed over to the second apparatus:
sending a second message to the one or more terminal apparatuses, wherein the second message is usable to indicate the terminal apparatuses to be handed over to the second apparatus; and
after the one or more terminal apparatuses are handed over to the second access network apparatus, switching off one or more cells.

2. The method according to claim 1, further comprising:
multicasting the second message to the one or more terminal apparatuses, wherein the second message includes dedicated configuration information and common configuration information, the dedicated configuration information includes one or more of the following:
random access channel (RACH) configuration information of the one or more terminal apparatuses, or channel state information (CSI) or measurement configuration information of the one or more terminal apparatuses, and the common configuration information includes one or more of the following: physical downlink control channel (PDCCH) configuration information, physical downlink shared channel (PDSCH) configuration information, physical uplink control channel (PUCCH) configuration information, or physical uplink shared channel (PUSCH) configuration information.

3. The method according to claim 1, further comprising:
multicasting the second message to the one or more terminal apparatuses, wherein the second message carries common configuration information, and the common configuration information includes one or more of the following: physical downlink control channel (PDCCH) configuration information, physical downlink shared channel (PDSCH) configuration information, physical uplink control channel (PUCCH) configuration information, or physical uplink shared channel (PUSCH) configuration information; and
unicasting corresponding dedicated configuration information to the one or more terminal apparatuses, wherein the dedicated configuration information includes one or more of the following information: random access channel (RACH) configuration information corresponding to the one or more terminal apparatuses, or channel state information (CSI) or measurement configuration information of the one or more terminal apparatuses.

4. The method according to claim 1, further comprising:
sending a third message to the second apparatus, wherein the third message is used usable to request to switch off the one or more cells; and
receiving a third response message from the second apparatus for the third message, wherein the third response message is usable to indicate that the one or more cells are allowed to be switched off.

5. The method according to claim 1, wherein the first message is further usable to indicate to request to switch off the one or more cells, and the first response message is usable to indicate that the one or more cells are allowed to be switched off.

6. The method according to claim 1, further comprising:
sending a fourth message to the second apparatus, wherein the fourth message is usable to notify that the first apparatus is to switch off the one or more cells; and
receiving a fourth response message from the second apparatus for the fourth message, wherein the fourth response message is usable to indicate that the one or more cells are allowed to be switched off.

7. The method according to claim 1, further comprising:
receiving a twelfth message sent by the second apparatus, wherein the twelfth message is usable to indicate the first apparatus to switch off the one or more cells.

8. The method according to claim 1, further comprising:
receiving a first configuration message from the second apparatus, wherein the first configuration message includes configuration information of a data radio bearer (DRB); and
forwarding data of a first terminal apparatus to the second apparatus through one or N DRBs corresponding to the first terminal apparatus, wherein the first terminal apparatus is any one of the one or more terminal devices, and N is a positive integer and is greater than 1.

9. The method according to claim 1, further comprising:
receiving a second configuration message from the second apparatus, wherein the second configuration message includes configuration information of one or more data radio bearers (DRBs); and
forwarding data of a first terminal apparatus to the second apparatus through the one or more DRBs, wherein a packet header of the data includes one or more of the following: an identifier of the first terminal apparatus and a length of the data, and the first terminal apparatus is any one of the one or more terminal apparatuses.

10. A first apparatus, comprising:
a memory storing a computer program or instructions; and
a processing circuit coupled to the memory, wherein the processing circuit is configured to execute the computer program or instructions, to cause the first apparatus to:
send a first message to a second apparatus, wherein the first message is usable to request to hand over a group of terminal apparatuses under the first apparatus to the second apparatus, and the group of terminal apparatuses includes one or more terminal apparatuses:
receive a first response message from the second apparatus for the first message, wherein the first response message is usable to indicate that the one or more terminal apparatuses are allowed to be handed over to the second apparatus:
send a second message to the one or more terminal apparatuses, wherein the second message is usable to indicate the terminal apparatuses to be handed over to the second apparatus; and
after the one or more terminal apparatuses are handed over to the second apparatus, switching off one or more cells.

11. The first apparatus according to claim 10, wherein the processing circuit is further configured to execute a computer program or instructions stored in the memory, to further cause the first apparatus to:
multicast the second message to the one or more terminal apparatuses, wherein the second message includes dedicated configuration information and common configuration information, the dedicated configuration information includes one or more of the following: random access channel (RACH) configuration information of the one or more terminal apparatuses, or channel state information (CSI) or measurement configuration information of the one or more terminal apparatuses, and the common configuration information includes one or more of the following: physical downlink control channel (PDCCH) configuration information, physical downlink shared channel (PDSCH) configuration information, physical uplink control channel (PUCCH) configuration information, or physical uplink shared channel (PUSCH) configuration information.

12. The first apparatus according to claim 10, wherein the processing circuit is further configured to execute a computer program or instructions stored in the memory, to further cause the first apparatus to:
multicast the second message to the one or more terminal apparatuses, wherein the second message carries common configuration information, and the common configuration information includes one or more of the following: physical downlink control channel (PDCCH) configuration information, physical downlink shared channel (PDSCH) configuration information, physical uplink control channel (PUCCH) configuration information, or physical uplink shared channel (PUSCH) configuration information; and
unicast corresponding dedicated configuration information to the one or more terminal apparatuses, wherein the dedicated configuration information includes one or more of the following information: random access channel (RACH) configuration information corresponding to the one or more terminal apparatuses, or channel state information (CSI) or measurement configuration information of the one or more terminal apparatuses.

13. The first apparatus according to claim 10, wherein the processing circuit is further configured to execute a computer program or instructions stored in the memory, to further cause the first apparatus to:
send a third message to the second apparatus, wherein the third message is usable to request to switch off the one or more cells; and
receive a third response message from the second apparatus for the third message, wherein the third response message is usable to indicate that the one or more cells are allowed to be switched off.

14. The first apparatus according to claim 10, wherein the first message is further usable to indicate to request to switch off the one or more cells, and the first response message is usable to indicate that the one or more cells are allowed to be switched off.

15. The first apparatus according to claim 10, wherein the processing circuit is further configured to execute a computer program or instructions stored in the memory, to further cause the first apparatus to:
send a fourth message to the second apparatus, wherein the fourth message is usable to notify that the first apparatus is to switch off the one or more cells; and
receive a fourth response message from the second apparatus for the fourth message, wherein the fourth response message is usable to indicate that the one or more cells are allowed to be switched off.

16. The first apparatus according to claim 10, wherein the processing circuit is further configured to execute a computer program or instructions stored in the memory, to further cause the first apparatus to:
receive a twelfth message sent by the second apparatus, wherein the twelfth message is usable to indicate the first apparatus to switch off the one or more cells.

17. The first apparatus according to claim 10, wherein the processing circuit is further configured to execute a computer program or instructions stored in the memory, to further cause the first apparatus to:
receive a first configuration message from the second apparatus, wherein the first configuration message includes configuration information of a data radio bearer (DRB); and
forward data of a first terminal apparatus to the second apparatus through one or N DRBs corresponding to the first terminal apparatus, wherein the first terminal apparatus is any one of the one or more terminal devices, and N is a positive integer and is greater than 1.

18. The first access apparatus according to claim 10,
wherein the processing circuit is further configured to execute a computer program or instructions stored in the memory, to further cause the first apparatus to:
receive a second configuration message from the second apparatus, wherein the second configuration message includes configuration information of one or more data radio bearers (DRBs); and
forward data of a first terminal apparatus to the second apparatus through the one or more DRBs, wherein a packet header of the data includes comprises one or more of the following: an identifier of the first terminal apparatus and a length of the data, and the first terminal apparatus is any one of the one or more terminal apparatuses.

19. A non-transitory computer-readable storage medium, wherein the storage medium stores a computer program or instructions, and in response to the computer program or the instructions being executed by a first apparatus, cause the first apparatus to:
send a first message to a second apparatus, wherein the first message is used usable to request to hand over a group of terminal apparatuses under the first apparatus to the second apparatus, and the group of terminal apparatuses includes one or more terminal apparatuses:
receive a first response message from the second apparatus for the first message, wherein the first response message is usable to indicate that the one or more terminal apparatuses are allowed to be handed over to the second apparatus;
send a second message to the one or more terminal apparatuses, wherein the second message is usable to indicate the terminal apparatuses to be handed over to the second apparatus; and
after the one or more terminal apparatuses are handed over to the second apparatus, switching off one or more cells.

20. The non-transitory computer-readable storage medium according to claim 19, wherein in response to the computer program or the instructions being executed by the first apparatus, further cause the first apparatus to:
multicast the second message to the one or more terminal apparatuses, wherein the second message includes dedicated configuration information and common configuration information, the dedicated configuration information includes one or more of the following: random access channel (RACH) configuration information of the one or more terminal apparatuses, or channel state information (CSI) or measurement configuration information of the one or more terminal apparatuses, and the common configuration information includes one or more of the following: physical downlink control channel (PDCCH) configuration information, physical downlink shared channel (PDSCH) configuration information, physical uplink control channel (PUCCH) configuration information, or physical uplink shared channel (PUSCH) configuration information.
